(19) United States
(12) Patent Application Publication
(10) Pub. No.: US 2013/0249375 A1
(43) Pub. Date: Sep. 26, 2013

(54) ANTI-ICING SOLID STATE AIRCRAFT LAMP ASSEMBLY WITH DEFROSTER APPARATUS, SYSTEM, AND METHOD

(71) Applicants: George W. Panagotacos, Corona, CA (US); David G. Pelka, Los Angeles, CA (US)

(72) Inventors: George W. Panagotacos, Corona, CA (US); David G. Pelka, Los Angeles, CA (US)

(21) Appl. No.: 13/426,410

(22) Filed: Mar. 21, 2012

(51) Int. Cl. H01J 7/24; F24J 1/00; H05B 3/02

(52) U.S. Cl. 313/13; 219/220; 126/263.01; 313/15

(57) ABSTRACT

Anti-icing solid state aircraft lamps are disclosed. The anti-icing solid state aircraft lamp includes at least one solid state light source, a substantially optically transparent cover optically coupled to the at least one solid state light source, and at least one defroster element coupled to the optically transparent cover.

### BACKGROUND

The present disclosure is related generally to an anti-icing solid state aircraft lamp assembly comprising a defroster apparatus, system, and method. A defroster apparatus, system, and method includes any defogger, demister, or deicing apparatus, system, and method to clear or evaporate condensation or fog and thaw or deice rime, frost, snow, or ice that may develop on the clear cover portion of the anti-icing lamp assembly. More particularly, the present disclosure is directed to a light emitting diode (LED) based solid state lamp assembly with defroster elements to defog the clear cover of the lamp assembly.

Conventional aircraft landing and taxiing lights on transport and commercial aircraft utilize a filament or gas that emits light when a voltage is applied. In addition, such conventional aircraft landing and taxiing lights produce heat through infrared (IR) wavelength transmission during operation. Such IR radiation generally develops enough heat to prevent the formation of rime or clear ice in adverse weather conditions. Solid state lamps such as LED based aircraft lamps emit light and/or pump phosphor to produce white light. Such solid state lamps, however, do not produce a significant amount of energy in the IR wavelength band and therefore do not radiate enough heat to the cover (e.g., glass enclosure) of the lamp assembly during operation. As a result, condensation, fog, rime, frost, snow, or ice, and the like, can form on the cover of solid state LED lamp assemblies used in external aircraft lighting applications, such as landing and taxiing, to degrade the ability of LED based lamps to properly illuminate runway during landing and taxiing operations.

The present disclosure provides a brief review of the current state of LED technology. In addition, the present disclosure considers the fabrication and radiation emitted by white LEDs, their size, as well as their potential for increasing nighttime visual acuity. Further, the compelling reasons for LEDs gaining market share as a light source for both new and retrofit lamps for the large commercial aircraft is examined. State-of-the-art LED metrics such as chip size, lumens per watt, thermal resistance, and heat transfer properties are also examined. Finally, the present disclosure describes the importance of non-imaging optics for both optically efficient and extremely compact LED lighting systems as direct drop-in replacements for conventional and ubiquitous incandescent aircraft lamps, such as incandescent aircraft lamps available from General Electric known as GE 4553 aircraft landing lights. Additionally, the present disclosure describes how LED based lamps consume much less power than the conventional incandescent and halogen lamps and have lifetimes on the order of 500-1000 times those of existing lamps.

Prior to describing the various embodiments of defroster elements, this disclosure will turn briefly to a discussion of the historical context of the LED as a light source generally. It is generally accepted that there have been two major revolutions in lighting technology during the 19th and 20th centuries. The first revolution would consist of the development of the incandescent light bulb from the early 1800s, through Thomas Edison's commercialization of the technology in 1880. Actually the incandescent bulb, as we know it, was not in its final form until approximately 1910 when the tungsten filament was invented and the cost of incandescent lamps came down to level that most people could afford. The second revolution in lighting occurred in 1938 when researchers at General Electric Corp. (GE) invented the fluorescent lamp. This new fluorescent lamp had twice the energy efficiency of the incandescent lamp and twice its lifetime. Continued refinements of the fluorescent lamp over the past 73 years have resulted in its efficacy growing to seven times that of the incandescent lamp (100 lumens per watt [lm/W]) and its lifetime growing to 10 times that of incandescent lamp (20,000 hours). Because of these characteristics, the fluorescent lamp has become the lamp of choice for most commercial, government, and institutional facilities. Further, the incandescent lamp (and its offshoot the halogen lamp) continues to be the lamp of choice for most residential and high-power parabolic reflector (PAR) lamp applications. An example would be landing lights on large commercial aircraft because of the incandescent bulbs relatively small filament and high luminance when compared to fluorescent lamps.

The third revolution in lighting got started quietly in 1962 with the first practical demonstration of the LED by Nick Holonyak (N. Holonyak Jr., S. F. Bevaqua, Appl. Phys. Lett. 1, 82 (1962), the disclosure of which is herein incorporated by reference) working at General Electric Laboratories. The first LEDs had luminous efficacies of only about 0.1 lm/W (i.e. about 1/20 the efficacy of Edison's first electric light bulb), and came only in red and yellow colors. During the ensuing 30 years, LEDs' efficiencies gradually increased, with their chief applications being as idiot lights, to alert you as to when your stereo or radio was on or off. In 1992, however, there was a dramatic increase in the efficacy of the red and amber LEDs, which previously had been made from GaAsP or GaP material, were now made from a new quatenary solid state material, AlInGaP, and their efficiency jumped from 1 to 2 lm/W into the range of 10 to 20 lm/W. At this point LEDs exceeded the efficiency of red color filtered incandescent lamps and the consumer began seeing applications of red LEDs into automobile taillight assemblies and red traffic signals.

Even with all progress made in development of LEDs over this 30 year period, there was still a key missing link, bright blue and green LEDs. This problem was soon-to-be remedied, however, by Shuji Nakamura (S. Nakamura, M. Senoh, N. Iwasa, S. Nagahama, T. Yamada, T. Mukai, Jpn. J. Appl. Phys. 34, L1332 (1995), the disclosure of which is herein incorporated by reference) working at Nichia Corporation in late 1993 with his new method of producing very bright blue and green LEDs from GaN material. These new Nichia blue and green LEDs had approximately 100 times the flux output of the previous best blue and green LEDs, and opened up a whole range of new applications for LEDs in the general lighting marketplace. In addition, Nichia introduced a “white LED” by taking a blue LED and covering it with a YAG (yttrium aluminum garnet) yellow phosphor. During the past twenty years there have continued to be dramatic increases in the efficiency of all these LEDs, and there are now compelling reasons to believe that these solid state lighting (SSL) devices will indeed usher in a third revolution in lighting. The compelling reasons for LEDs being hailed as the 3rd revolution in lighting will now be examined in some detail.

An LED in its simplest form is a semiconductor p-n junction device that, when forward biased with a direct current (dc) flowing through its p-n junction emits photons as a result of the electrons and holes recombining near the junction. The energy of the photons is primarily determined by the energy band gap of the semiconductor where the recombination occurs. Compound semiconductor materials composed of column III and V elements (from the Periodic Chart) are the materials of choice for LEDs because they have direct band gap properties and band gap energies necessary for efficiently producing visible photons. The best AlInGaP LEDS (red and amber) convert about 50% of the electrons sent into their p-n junctions directly into useful light output. The best InGaN LEDs (UV, blue, green and white) convert 40% of electrons traveling through their p-n junctions into useful light output.

The drive voltages for AlInGaP LEDs are typically from 1.8V-3.0V dc, while drive voltages for InGaN are in the range of from 3.0V-3.6V dc. In general, LED manufacturers recommended that the junction temperature of all LEDs be kept at less than 150° C. Most LEDs are encapsulated by an epoxy which undergoes thermal degradation (epoxy yellowing) at temperatures in excess of 125° C. This yellowing greatly reduces light output and lifetime, particularly for the blue and green LEDs, if this metric is not adhered to. The size of LED die for the ordinary LED packages range from 0.25 mm-0.35 mm on a side while those for the so called power (high flux) LED packages range from 1.0 mm to 2.0 mm on a side.

LEDs are provided in three fundamental packages: (1) 5 mm so called “bullet” lens, with typical drive currents of 20-40 mA and with thermal resistances of 200-300° C./W (this is the thermal resistance between the LED die to ambient); (2) surface mount (SMT)LEDs (high speed pick and place), with typical drive currents of 10-100 ma and with thermal resistance of 150-300° C./W; and (3) Power (high flux) LEDs, with typical drive currents from 350-3000 ma with thermal resistances of 3-10° C./W.

One misconception regarding LEDs is that they are a cool light source. This probably stems from the fact that most people have experience with 5 mm bullet lens packages which typically run at 30 mA and 3.3 V for the white LEDs, for power consumption of approximately 0.1 watts. Recall that about 40% of this power goes into creating light, while 60% is emitted as heat from the LED. Thus, when dealing with power consumption as low as 0.06 watts, one can easily come away with the false impression that LEDs are indeed a cool light source.

Taking into consideration the case of using white high-power LEDs to replace a 250 watt GE model 4553 incandescent aircraft landing lamp, which when new is rated at approximately 4500 lumens, and see if we still believe that LEDs are a cool light source. At today's efficacy figures of 100 lm/W for the white high-power LEDs, for example the Cree XM-L LED run at 3,000 mA at 3.35 Vdc (a 10 watt source) produces about 680 lumens, we would require about 7 of these 10 watt LEDs to produce the 4500 lumens. Assuming that 40% of the power goes into creating light and that 60% goes into creating heat, we would need to dissipate 42 watts of heat, far from a cool light source. While this is not a tough task if one can radiate this power away as the temperature to the fourth power (T⁴) as an incandescent lamp does via radiative heat transfer, it is a much more difficult task for an LED lamp composed of this array of 7 LEDs which can basically only use conduction in order to remove the 42 watts of heat through the base of the LED array. Indeed, when one takes into account that LED light output degrades with rising junction temperature, it becomes almost inescapable that one requires a lot of intelligent design for the heat transfer to be used in conjunction with his LED array. Even if one projects forward one year and assuming that white LEDs have achieved an efficacy of 150 lm/W, one would still require three of the these 10 W white LEDs to create the 4500 lumens and that still implies the need to dissipate approximately 18 watts of power.

The conclusion one is left with is that LEDs are not a cool light source even though today they have approximately seven times the efficacy of an incandescent bulb, and in the near future probably 10× the efficacy of an incandescent bulb. The ability of incandescent lamps to get rid of excess heat via radiation transfer is their fundamental advantage over LEDs. Since LEDs must have their junction temperature maintained at no more than 150° C., they are constrained to basically use only conduction to rid themselves of excess heat.

The luminous efficacy (ηL) of incandescent lamps, halogen lamps, fluorescent lamps, sodium-vapour lamps and commercial white LEDs is discussed in a historical context in Urataki E. and Suzuki Y. 2001 J. Illum. Eng. Inst. Japan 85 4, the disclosure of which is incorporated herein by reference. The incandescent lamp was developed in 1879, and in the 150 years that followed, the ηL of incandescent lamps was enhanced from 1.5 to 16 lmW⁻¹. The fluorescent lamp was developed in 1938, and their luminous efficacy was enhanced from 50 to 100 lmW⁻¹ over the following 60 years. The sodium-vapour lamp was developed in 1965, and its ηL was enhanced from 106 to 146 lmW⁻¹ over the next 40 years. Thus, the typical improvement rate in traditional lamps was only 1.1-1.2 times per decade. Within the past 30 years, the ηL of these lamps has remained nearly constant. On the other hand, the white LED was first commercialized in 1996. The ηL of white LEDs in 1996 was only 5 lmW⁻¹, much lower than that of an incandescent lamp (13 lmW⁻¹ However, the ηL of white LEDs was very rapidly enhanced due to improvements in the external quantum efficacy (ηex) of blue LEDs. The highest ηL of current commercial white LED has reached 150 lmW⁻¹, the highest value of all white light sources. The white LEDs was drastically improved, compared with that of traditional lamps, by about 30 times per decade, and has not yet saturated. The possibility of further enhancement of the ηL of white LEDs remains.

### SUMMARY

In one embodiment, an anti-icing solid state aircraft lamp comprises at least one solid state light source, a substantially optically transparent cover optically coupled to the at least one solid state light source, and at least one defroster element coupled to the optically transparent cover.

### DESCRIPTION OF THE FIGURES

FIGS. 1A, 1B and 1C are perspective views of a front, back and side, respectively, of an anti-icing lamp assembly according to one embodiment.

FIG. 2 is a perspective cross-sectional view of the anti-icing lamp assembly of FIGS. 1A-1C.

FIG. 3 is an exploded view of the anti-icing lamp assembly of FIGS. 1A-1C.

FIG. 4A illustrates a physical layout of the LED arrays and controller circuit of FIG. 3.

FIG. 4B illustrates a configuration of the PCB substrate of FIG. 4A according to one embodiment

FIGS. 5A and 5B illustrate configurations of an LED array of FIG. 3 according to various embodiments.

FIG. 6 is a cross-sectional view of the structure of a phosphor-conversion white LED lamp shown in FIG. 6 using a blue LED die and a yellow phosphor material.

FIG. 7 is a schematic diagram of the white LED lamp shown in FIG. 6 producing white light.

FIG. 8 is a graphical depiction of a typical emission spectrum of a white LED using a Yttrium-Aluminum-Garnet (YAG) phosphor at a forward-bias current of about 20 mA.

FIG. 9 shows the spectrum of an ultra-high Ra white LED (UHR-white), with a T_{cp}, of 5000 K.

FIG. 10 is a block diagram of the LED arrays and controller circuit of FIG. 3 according to one embodiment.

FIGS. 11A, 11B, 11C are front, back and perspective side views, respectively, of the base of FIG. 3 according to one embodiment.

FIGS. 12A and 12B are perspective views of one set of electrical connectors of FIG. 3 according to one embodiment.

FIGS. 13A, 13B, and 13C are front, back and perspective side views, respectively, of the cover of FIG. 3 according to one embodiment.

FIGS. 14A and 14B illustrate diffuser optics according to various embodiments.

FIG. 15 is a cross-sectional view of a non-imaging lens called a total internal reflection (TIR) lens according to one embodiment.

FIG. 16 shows an incandescent landing light comprising a parabolic reflector.

FIG. 17 shows one embodiment of an m-TIR lens comprising a mushroom-shaped deviator lens and a TIR lens according to one embodiment.

FIG. 18 shows one embodiment of the mushroom-shaped deviator lens shown in FIG. 17 in combination with the TIR lens denoted as m-TIR lens with computer generated ray tracing according to one embodiment.

FIG. 19 is a computer modeled performance of an m-TIR lens assembly where the solid line is the relative intensity for degrees off-axis and the dotted line is cumulative according to one embodiment.

FIG. 20 illustrates a lamp assembly comprising a plurality of m-TIR lenses according to one embodiment.

FIGS. 21, 22, 23 illustrate an anti-icing lamp assembly comprising a transparent electrically conductive coating according to one embodiment, where FIG. 21 is perspective cross-sectional view, FIG. 22 is a detail view of a cross-section of a cover of the anti-icing lamp assembly, and FIG. 23 is an exploded view.

FIG. 24 illustrates an anti-icing lamp assembly comprising an electrically resistive conductor according to one embodiment.

FIG. 25 illustrates an anti-icing lamp assembly comprising an electrically resistive conductor according to one embodiment.

FIG. 26 illustrates an anti-icing lamp assembly comprising an electrical resistance conductive grid element according to one embodiment.

FIG. 27 illustrates an anti-icing lamp assembly comprising an exothermic deicing system according to one embodiment.

FIG. 28 illustrates an anti-icing lamp assembly comprising an infrared thermal energy sources according to one embodiment.

FIGS. 29 and 30 illustrate an anti-icing lamp assembly comprising a heat sink thermal energy transfer system according to one embodiment.

FIGS. 31A, 31B and 31C are perspective views of a front, back and side, respectively, of an anti-icing lamp assembly according to one embodiment.

FIGS. 32 and 33 are exploded views of the anti-icing lamp assembly of FIGS. 31A-31C according to one embodiment.

FIG. 34 is a perspective cross-sectional view of one embodiment of an anti-icing lamp assembly according to one embodiment.

FIG. 35 is a detail view of a cross-section of the lens cover of the anti-icing lamp assembly of FIG. 34 according to one embodiment.

FIG. 36 illustrates an exploded view the anti-icing lamp assembly with the retainer ring removed to more clearly show the outer surface 602 of the cover according to one embodiment.

FIG. 37 illustrates an anti-icing lamp assembly comprising electrically resistive heater conductors according to one embodiment.

FIG. 38 illustrates an anti-icing lamp assembly comprising electrically resistive heater conductors according to one embodiment.

FIG. 39 illustrates an anti-icing lamp assembly comprising electrically resistive heater conductors according to one embodiment.

FIG. 40 illustrates an anti-icing lamp assembly comprising an exothermic deicing thermal energy system according to one embodiment.

FIG. 41 illustrates one embodiment of an anti-icing lamp assembly comprising an infrared (IR) thermal energy source according to one embodiment.

FIG. 42 illustrates one embodiment of an anti-icing lamp assembly comprising a heat sink thermal energy transfer system according to one embodiment.

FIG. 43 illustrates one embodiment of a controller circuit for controlling the operation of the anti-icing lamp assembly according to one embodiment.

FIG. 44 illustrates one embodiment of a control circuit suitable for use with a thermistor type feedback element.

FIG. 45 illustrates an installed configuration of an anti-icing lamp assembly according to one embodiment.

### DESCRIPTION

Before explaining the present disclosure in detail, it should be noted that the disclosed embodiments are not limited in application or use to the details of construction and arrangement of parts illustrated in the accompanying drawings and description. The disclosed embodiments may be implemented or incorporated in other embodiments, variations and modifications, and may be practiced or carried out in various techniques. Further, unless otherwise indicated, the terms and expressions employed herein have been chosen for the purpose of describing the illustrative embodiments for the convenience of the reader and are not for the purpose of limitation thereof. Additionally, it should be understood that any one or more of the disclose embodiments, expressions of embodiments, and examples, can be combined with any one or more of the other disclosed embodiments, expressions of embodiments, and examples in whole or in part without limitation.

The present disclosure is directed generally to an anti-icing solid state aircraft lamp assembly comprising a defroster apparatus, system, and method. A defroster apparatus, system, and method includes any defogger, demister, or deicing apparatus, system, and method to clear or evaporate condensation or fog and thaw or deice rime, frost, snow, or ice that may develop on the clear cover portion of the anti-icing lamp assembly. More particularly, the present disclosure is directed to an LED based solid state lamp assembly with defroster elements to defog the clear cover of the lamp assembly. The embodiments of the anti-icing solid state aircraft lamp assemblies disclosed herein are configured with defroster elements to defog, demist, deice, prevent icing, clear or evaporate condensation or fog and thaw rime, frost, snow, or ice that may develop on the clear cover portion of the lamp assembly or prevent the buildup of any of these conditions on the clear cover portion of the lamp assembly. In one embodiment, the clear cover portion of the lamp assembly comprises a feedback element, which provides a feedback signal indicative of a condition of the clear cover, such as, for example, fog, mist, ice, rime, frost, snow, ice or temperature to the controller circuit. In response to the feedback signal, the controller circuit activates the defroster element to defog, demist, deice, prevent icing, clear or evaporate condensation or fog and thaw rime, frost, snow, or ice that forms on the clear cover.

It will be appreciated that the controller circuit may be activated in response to monitored environmental conditions external to the lamp assembly, such as temperature, for example, to prevent or arrest the development of fog, mist, ice, rime, frost, or snow. For conciseness and clarity of disclosure, for example, these functions are referred to herein simply as “deicing” the clear cover portion of the lamp assembly, without limitation. For example, in the context of the present disclosure, the term “deicing” may be used to describe the function of: removing or getting rid of fog, mist, ice, rime, frost, snow, or ice that had already developed on the cover; or preventing the development of fog, mist, ice, rime, frost, snow, or ice before it forms on the cover.

The defroster elements as described hereinbelow will enable the use of a solid state lamp, such as an LED based lamp, to perform without degradation during adverse weather conditions as described hereinbelow. As previously discussed, conventional aircraft landing and taxiing lamps utilize a filament or gas that emits heat in the IR spectrum when a voltage is applied to the lamp. In order to compensate for the lack of IR radiation in a solid state lamp suitable for defrosting the cover of a lamp assembly, for example, the present disclosure provides various embodiments of solid state LED based aircraft lamps comprising defroster elements formed integrally with, formed in, formed on, or coupled to an optically transparent cover of the solid state LED lamp for deicing the clear cover of an aircraft lamp assembly, for example.

One consideration that LED based aircraft lamp assemblies must overcome is one of deicing of landing lights in an aircraft. For incandescent lamps about 90% of their light is emitted as IR radiation that is heat, and therefore no ice can form on these incandescent landing lamps. LEDs, however, emit virtually no IR radiation and therefore augmentation must be added for the deicing function for LED landing lights. This can be accomplished via a transparent conductive surface coating that supplies heat, or by allowing for a conductive path from the base of the LED array to a conductive glass cover, or finally by either adding IR emitting LEDs into the array or tailoring the phosphor coating to emit some of its radiation in the IR portion of the spectrum. Various embodiments of these techniques are described hereinbelow in connection with various embodiments of aircraft lamp assemblies.

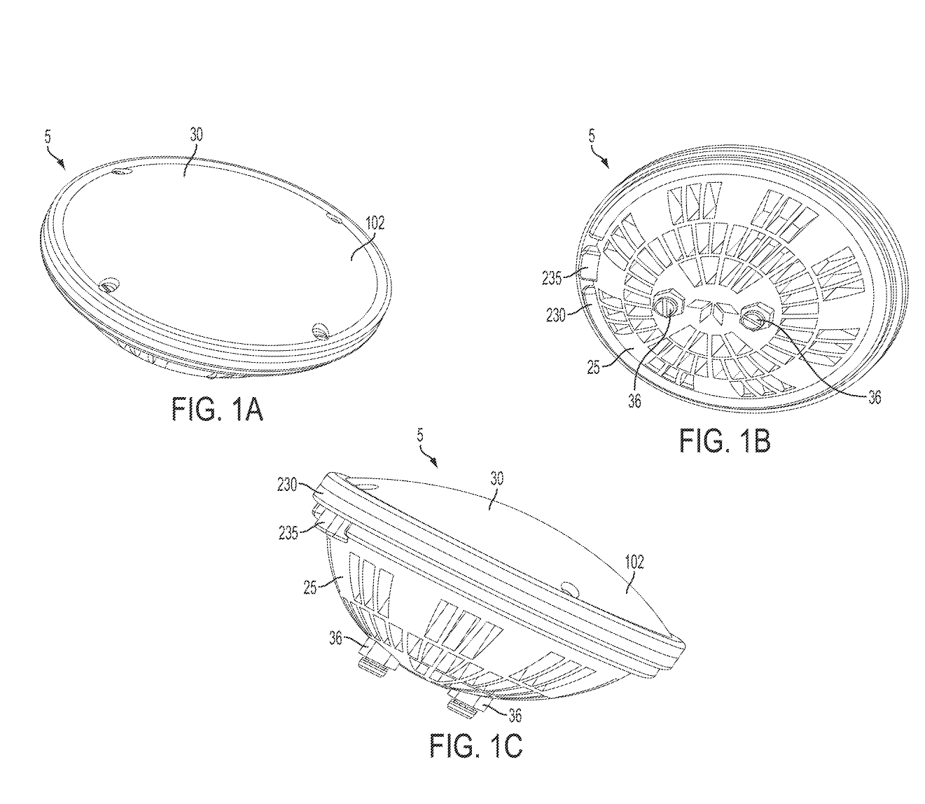

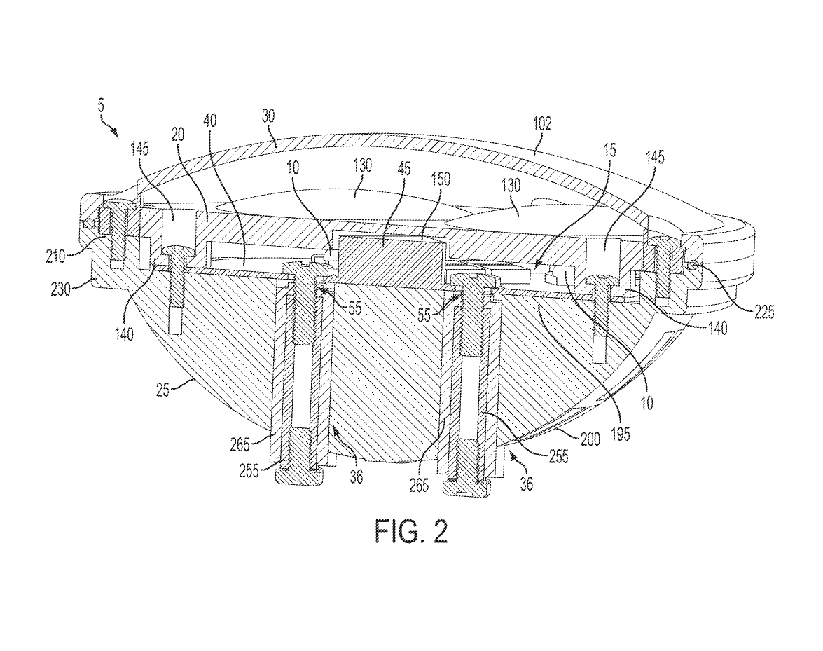

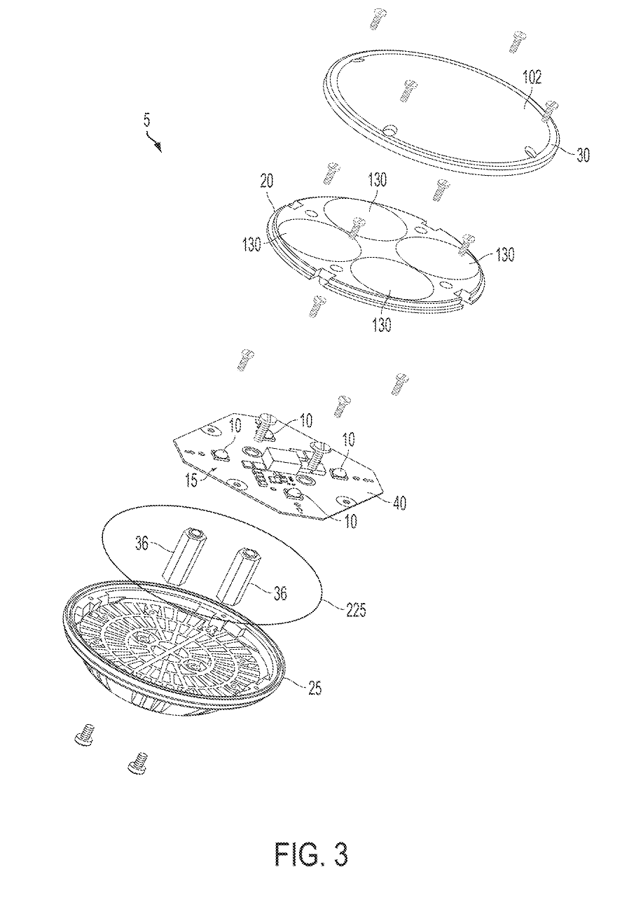

Prior to describing various embodiments of defroster elements for use in an anti-icing lamp assembly, the disclosure turns to FIGS. 1-30, which provides an overview of the optical, mechanical, and electronic components of one embodiment of an anti-icing lamp assembly, which may employ the various embodiments of defroster elements described herein. FIGS. 1A, 1B and 1C are perspective views of a front, back and side, respectively, of an anti-icing lamp assembly 5 according to one embodiment. FIG. 2 is a perspective cross-sectional view of the anti-icing lamp assembly 5, and FIG. 3 is an exploded view of the anti-icing lamp assembly 5 illustrating components thereof. As discussed in further detail below, embodiments of the anti-icing lamp assembly 5 utilize LED technology to generate a light output. Light emitting diodes do not exhibit the large inrush current characteristics of incandescent filaments and are generally impervious to vibration. The anti-icing lamp assembly 5 thus provides significantly greater operating lifetimes in harsh mechanical environments, such as, for example, aircraft, motorcycle and off-road vehicle (e.g., Baja 500) environments or the like than may be realized using incandescent filament technology. Advantages of the anti-icing lamp assembly 5 are not limited to increased durability and longevity in harsh operating environments, and it will be appreciated that the anti-icing lamp assembly 5 may be used in other operating environments, such as, for example, automobile forward lighting environments, marine (e.g., underwater) environments and stage lighting operating environments, and not just for aircraft applications. Because embodiments of the anti-icing lamp assembly 5 may utilize an array of total internal reflection (TIR) lenses to extract light from LEDs, the light may be collected and redirected more efficiently and compactly compared to non-TIR light processing elements used for external aircraft lighting and other applications. Moreover, because embodiments of the anti-icing lamp assembly 5 may conform to certain mechanical, electrical and/or light output specifications of any of a number of existing incandescent filament lamps, aircraft, motorcycles, off-road vehicles and other equipment (vehicular or non-vehicular) may be retrofitted with the anti-icing lamp assembly 5 without the need for substantial modification, if any, of the associated equipment.

With reference to FIG. 3, the anti-icing lamp assembly 5 may comprise at least one solid state light source, for example. In one embodiment, the solid state light source comprises at least one LED. In some embodiments, the solid state light source comprises at least one LED array 10, a controller circuit 15 electrically coupled to the LED arrays 10, a lens array 20, a base 25, and a cover 30. The cover 30 may be configured and adapted to accommodate various embodiments of the defroster elements described hereinbelow. The cover 30 may be formed of any suitable glass or plastic substrate. A glass substrate may be formed of borosilicate, whereas a plastic substrate may be formed of polycarbonate resin, acrylic resin, polyarylate resin, polyester resin, polysulfone resin, polyvinyl butyral resin (PVB), and copolymers and mixtures thereof.

The anti-icing lamp assembly 5 comprises a cover 30 that is substantially optically transparent. The cover 30 may comprise one or more defroster elements in accordance with the present disclosure to deice the cover 30, for example. As previously discussed, the term “deice” is used for conciseness and clarity and is intended to mean defog, demist, deice, prevent icing, clear or evaporate condensation or fog and thaw rime, frost, snow, or ice that may develop on the clear cover 30 of the anti-icing lamp assembly 5. The defroster elements may be configured to passively or directly provide thermal energy to an exterior surface 102 of the cover 30. In one embodiment, the defroster elements may be configured to generate thermal energy by conducting electrical current, alternating or direct current (AC or DC), pulsed, or modulated, through a resistive layer, coating, sheet, grid, or wire, or any combination thereof, formed integrally with or on an optically transparent substrate, e.g., the cover 30. In other embodiments, the defroster elements may be configured to generate thermal energy by exothermic chemical reactions that release energy in the form of heat. In other embodiments, the defroster elements may be configured to generate IR radiation energy. In other embodiments, the defroster elements may be configured as heat sinks to recover or recycle wasted heat from other sources in the lamp assembly or other aircraft systems. In other embodiments, heat sink elements embedded in the optically transparent substrate may be thermally coupled to other heat sink elements of the anti-icing lamp assembly 5 system. Before describing the various embodiments of defroster elements, the present disclosure continues with a description of one embodiment of the anti-icing lamp assembly 5.

In the assembled state of the anti-icing lamp assembly 5, as shown in FIG. 2, the LED arrays 10, the controller circuit 15 and the lens array 20 may be received onto a front surface 195 of the base 25, with the cover 30 being disposed over the front surface 195 and attached to the base 25. The LED arrays 10, the controller circuit 15 and the lens array 20 may thus be protectably enclosed between the cover 30 and the base 25. The anti-icing lamp assembly 5 may additionally comprise a set of electrical connectors 36 disposed through the base 25 between the front surface 195 of the base 25 and a back surface 200 of the base 25. As discussed in further detail below, the electrical connectors 36 enable an electrical power system external to the anti-icing lamp assembly 5 (e.g., an aircraft electrical power system) to electrically connect to the LED arrays 10 and controller circuit 15 and supply electrical power thereto.

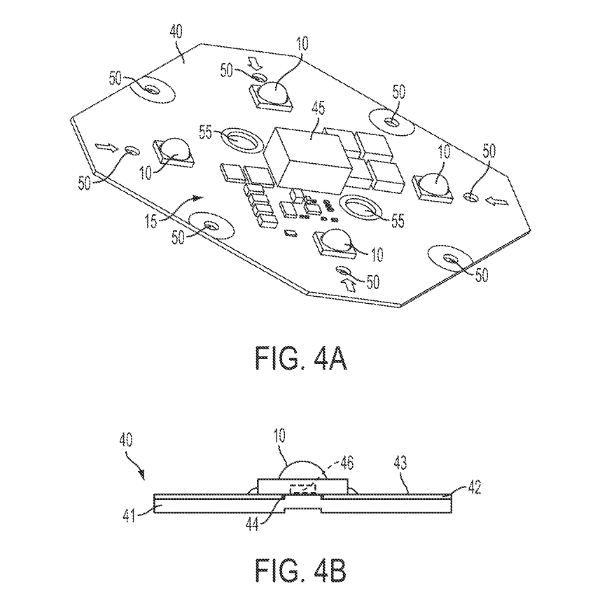

FIG. 4A illustrates a physical layout of the LED arrays 10 and controller circuit 15 of FIG. 3. As shown, the LED arrays 10 and controller circuit 15 may be mounted on a front surface of a printed circuit board (PCB) substrate 40, with the LED arrays 10 symmetrically spaced on an outer periphery of the substrate 40, and with the controller circuit 15 contained on a portion of the substrate 40 generally centered between the LED arrays 10. In certain embodiments and as shown in FIG. 4A, the anti-icing lamp assembly 5 may comprise four LED arrays 10, although it will be appreciated that any number of LED arrays 10, additional or fewer, may generally be used depending upon, for example, light output requirements of the particular lighting application and flux characteristics of the LED arrays 10. In certain embodiments and with reference to FIG. 4B, the substrate 40 may be in the form of a metal core PCB (MCPCB) comprising a metal base 41 (e.g., copper or aluminum), which may act as a heat sink, a dielectric layer 42 and a circuit layer 43 (e.g., copper) that are laminated together. At each location on the front surface of the substrate 40 at which an LED array 10 is mounted, a cutout 44 may be defined through the dielectric and circuit layers 42, 43 such at least a portion of each LED array 10 (e.g., an electrically insulated metal heat sink 46 of the LED array 10) is in direct thermal contact with the metal base 41. In one embodiment, for example, the heat sink 46 may be soldered to the metal base 41 via the cutout 44. In this way, a direct thermal path may be established between the LED arrays 10 and the base 25 through the metal base 41. In certain embodiments and as shown, the metal base 41 may be punched or slightly indented such that the portion of the metal base 41 exposed through each cutout is substantially flush with the front surface of the substrate 40. The LED arrays 10 and controller circuit 15 may be electrically connected by electrical conductors (not shown), such as, for example, electrical conductors formed in the circuit layer 43 using known circuit-forming technologies (e.g., photoengraving).

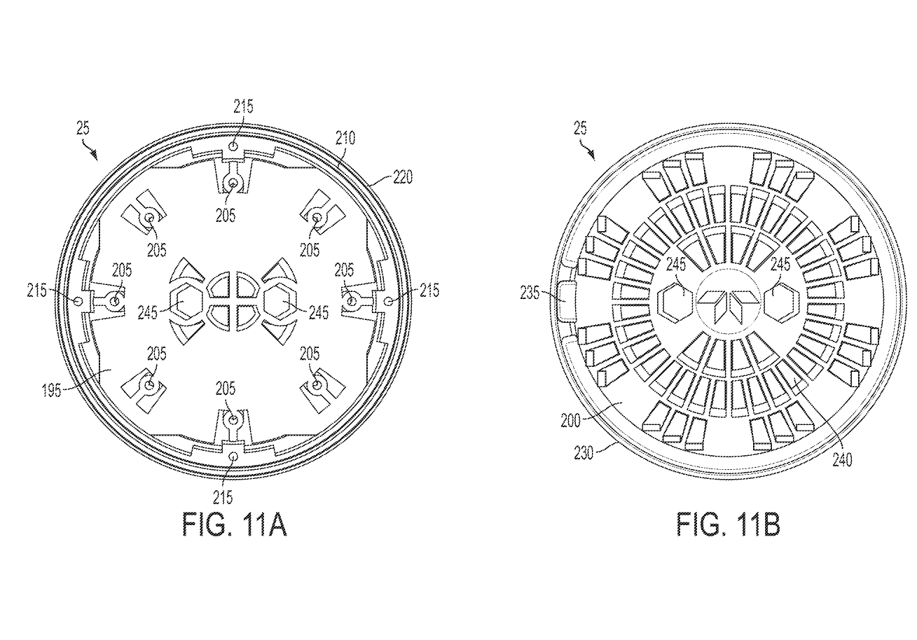

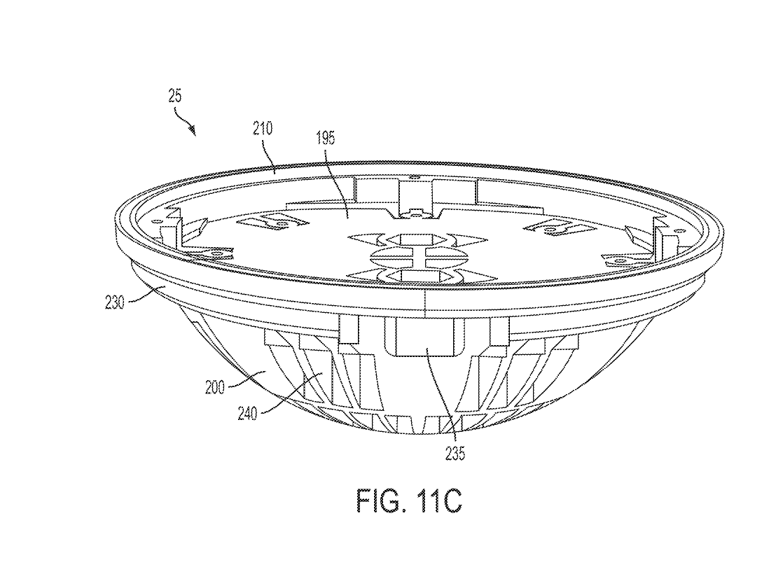

The front surface of the substrate 40 may comprise an alignment post 45 centered on the front surface and extending normally therefrom. When received into a corresponding alignment opening (not shown) of the lens array 20, the alignment post 45 ensures proper alignment of the lens array 20 with the LED arrays 10. The substrate 40 may define a number of suitably positioned openings 50 for enabling attachment of the substrate 40 and the lens array 20 to the base 25, using for example, fasteners (e.g., screws) introduced through the openings 50 that are retained in openings 205, 215 defined by the base 25 (FIGS. 11A-11C). The substrate 40 may additionally comprise a set of electrical input connection points in the form of openings 55 defined by the substrate 40, with each opening 55 having a conductive periphery electrically coupled to a corresponding input of the controller circuit 15. In the assembled state of the anti-icing lamp assembly 5 and with reference to FIG. 2, a fastener (e.g., a screw) received through each opening 55 may be retained by an end of a corresponding electrical connector 36, thereby mechanically anchoring the electrical connectors 36 to the substrate 40 and electrically connecting the electrical connectors 36 to the LED arrays 10 and controller circuit 15 via the conductive peripheries of the openings 55.

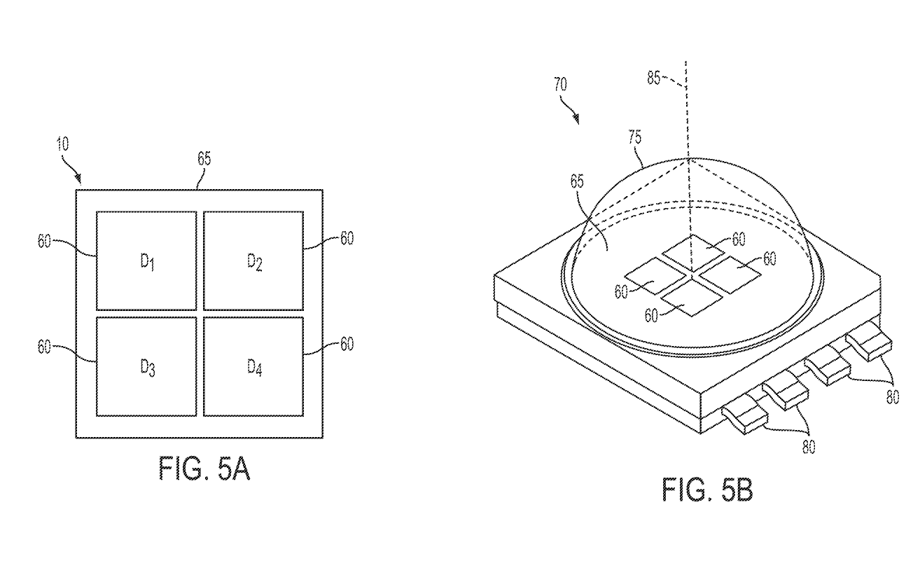

FIGS. 5A and 5B illustrate configurations of an LED array 10 of FIG. 3 according to various embodiments. In certain embodiments and with reference to FIG. 5A, the LED array 10 may comprise four LED die, or “LEDs,” 60 (D₁-D₄), with the LEDs 60 mounted onto a substrate 65 (which may or may not be the same as substrate 40) in the general form of a square when viewed from their light-emitting surfaces. In one embodiment, all LEDs 60 of the LED array 10 may be configured to radiate electromagnetic energy at substantially the same wavelength, or at a number of wavelengths that are substantially the same. In another embodiment, at least one of the LEDs 60 may be configured to radiate electromagnetic energy at one or more wavelengths that are not emitted by at least one other of the LEDs 60 of the LED array 10. The specific spectral output of the LED array 10 may be suitable for use in existing incandescent filament lamp applications, such as, for example, aircraft, motorcycle and off-road vehicle (e.g., Baja 500) applications, among others. Electrical connections to the LEDs 60 may be made through conventional electrical contacts.

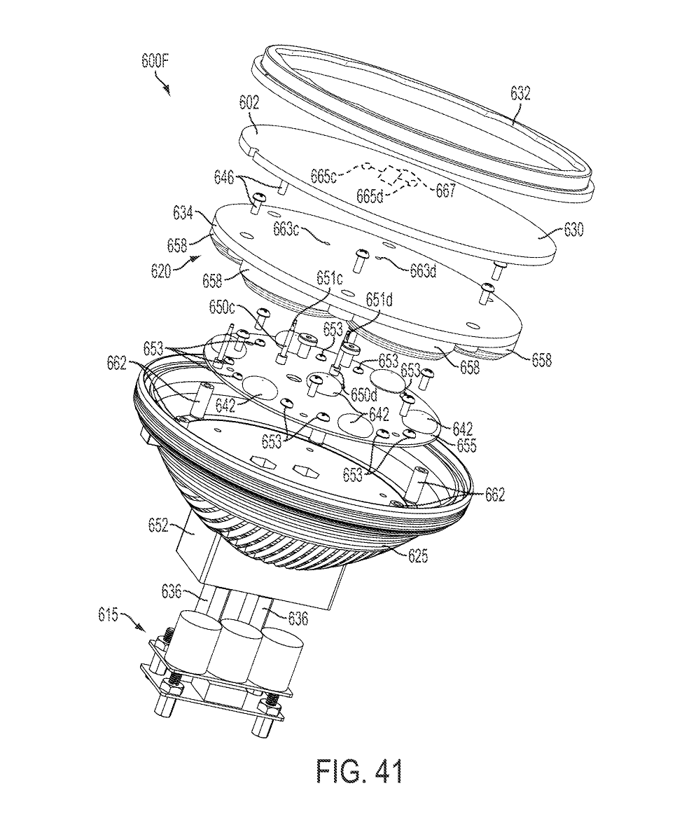

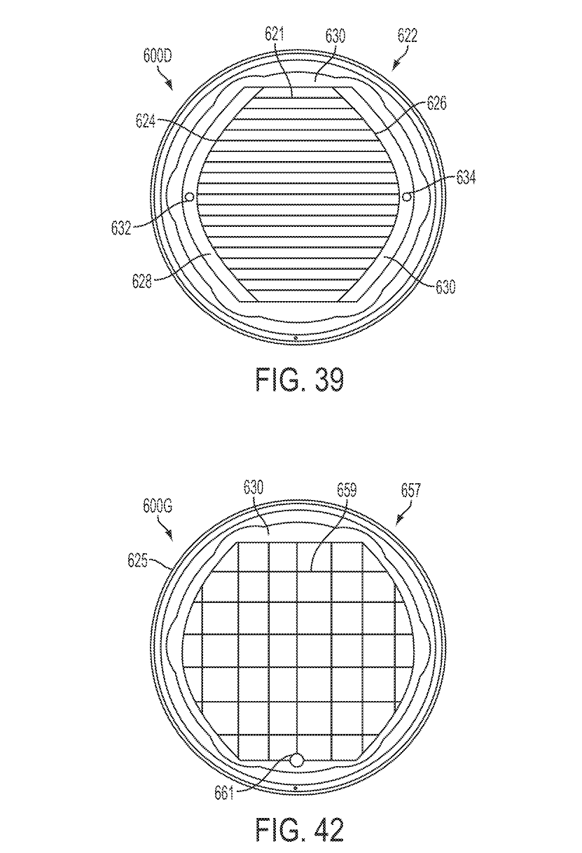

Although the LED array 10 of FIG. 5A comprises four LEDs 60 arranged in a square-like configuration, it will be appreciated that that the LED array 10 may generally comprise one or more LEDs 60, and that the one or more LEDs 60 may be mounted onto the substrate 65 to form any of a number of geometrical shapes (e.g., circle, line, rectangle, triangle, rhombus, or any suitable polygonal shape) depending on, for example, the number of LEDs 60 and a desired light distribution. It will further be appreciated that the number of LEDs 60 in each LED array 10 of the anti-icing lamp assembly 5 may or may not be the same. For example, in one embodiment all of the LED arrays 10 may comprise four LEDs 60, while in another embodiment a first LED array 10 may comprise four LEDs 60 and a second LED array 10 may comprise a number of LEDs 60 that is more or less than four. Similarly, it will be appreciated that the collective spectral output of each LED array 10 may or may not be the same as the spectral output of other LED arrays 10 of the anti-icing lamp assembly 5. In other embodiments, the LED array 10 also may include one or more IR LED heat sources for the purpose of generating heat to defrost the cover 30. Such IR heat sources can be controlled by the electronic circuit 15 separately from the lighting control only when defrosting is necessary to avoid wasting power. At least one additional embodiment of an IR LED heat source is described hereinbelow in connection with FIG. 41.

In certain embodiments and with reference now to FIG. 5B, the LED array 10 may be implemented using a commercially available LED package 70. The LED package 70 may be in the form of a surface-mount technology (SMT) component, for example, and comprise a number of LEDs 60 mounted onto a substrate 65, a lens 75 disposed over the LEDs 60, a heat sink (not shown) in thermal communication with the LEDs 60, and a set of pins or leads 80 electrically connected to each LED 60. In one such embodiment, for example, the LED package 70 may be implemented using an LED package known under the trade name of XLamp MC-E LED package available from Cree, Durham, N.C.

The LED array 10 may define a spatial radiation pattern having a central axis 85 about which light emitted by the LED array 60 is distributed in a generally symmetrical manner. With reference to FIG. 5B, for example, the central axis 85 may be centrally located between the LEDs 60 and extend normally from the substrate 65. In certain embodiments, the central axis 85 may coincide with a viewing angle of the LED array 10 (e.g., 0 degrees) at which the relative luminous intensity of the LED array 10 is at a maximum.

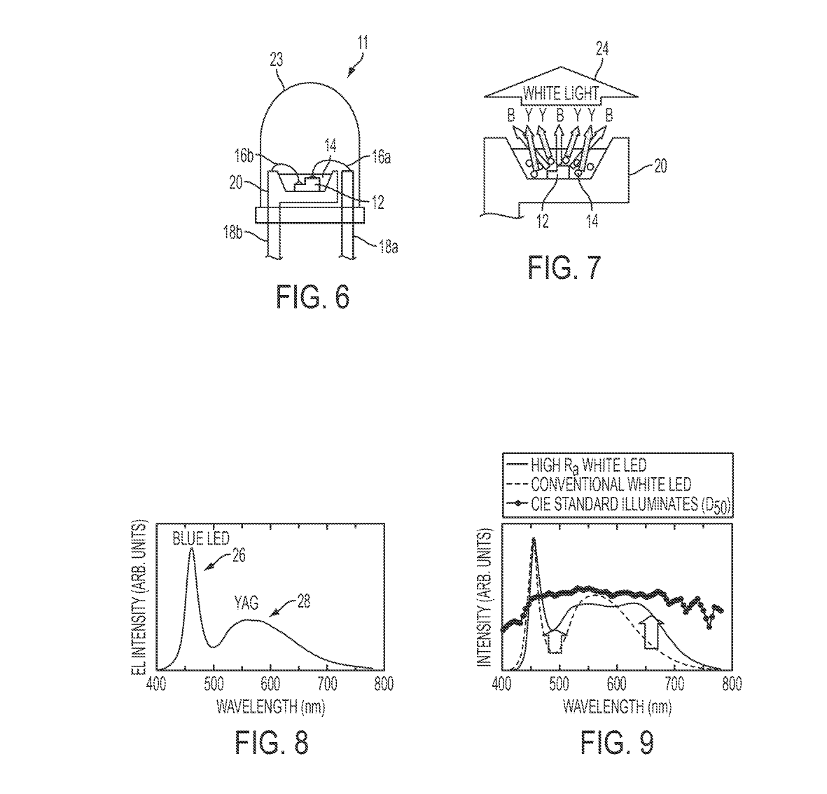

FIG. 6 is a cross-sectional view of the structure of a phosphor-conversion white LED lamp 11 that may be used in the LED array 10 of the anti-icing lamp assembly 5 discussed above with reference to FIGS. 5A, 5B and the anti-icing lamp assembly 600 discussed below. The LED lamp 11 comprises a blue LED die 12 and a yellow phosphor material 14. The LED die 12 is mounted in a cup 20 on a lead frame 18b and coated by the yellow phosphor material 14. Gold wires 16a, 16b are bonded to the corresponding lead frames 18a, 18b to provide the electrical contact. The LED die 12 and the phosphor material 14 are packaged by a resin formed into the shape of an optical lens 23. FIG. 7 is a schematic diagram of the white LED lamp 11 shown in FIG. 6 producing white light 24. The white LED lamp 11 produces white light 24 by mixing the blue emission from the LED die 12 with the yellow fluorescence from the phosphor material 14, which is excited by the blue emission of the LED die 12, as shown in FIG. 7. A commonly used yellow phosphor material 14 is YAG phosphor, which has very high wavelength conversion efficiency, high thermal stability, high material toughness, and a low production cost. Recently, several other yellow phosphors have been developed. However, there is not yet a yellow phosphor better than YAG phosphor overall, in terms of cost, optical properties and stability.

FIG. 8 is a graphical depiction of a typical emission spectrum of a white LED using a YAG phosphor, such as the phosphor-conversion white LED lamp 11 shown in FIGS. 6-7, at a forward-bias current of about 20 mA. The EI Intensity in arbitrary units is shown along the vertical axis and Wavelength (nm) is shown along the horizontal axis. The correlated color temperature T_{cp} is 6500 K. The spectrum consists of two peaks 26, 28, which correspond to the blue emission of the LED die at 460 nm and the yellow emission of the YAG phosphor at 555 nm, respectively. The full width at half maximum (FWHM) of the yellow emission is about 150 nm. Therefore, the spectrum of the white LEDs includes all visible wavelengths from blue to red. As a result, white LEDs have a high general color rendering index (Ra) of 85, which is equal to that of a tri-phosphor fluorescent lamp (Ra=85). This enables the use of white LEDs for general illumination. Unfortunately, the amount of luminescence in the red region of white LEDs is low. In order to enhance this red light, a red phosphor SrCaSiN: Eu can be added to a YAG white LED (Yamada M, Naitou T, Izuno K, Tamaki H, Murazaki Y, Kameshima M, and Mukai T, 2003 Japan J. App. Phys. 42L20 and Narukawa Y 2004 Opt. Photon News 15 24, the disclosures of each is herein incorporated by reference). As a result, CRI-No. 9, which shows color reproduction in the red region, was significantly enhanced from −2.5 to 62.6. Moreover, by using three phosphors (bluish-green, yellow and red), it is possible to obtain an Ra above 93, for all T_{cp} (Narukawa Y., Narita J., Sakamoto T., Yamada T., Narimatsu H., Sano M., and Mukai T., 2007 Phys. Status Solid at 204 2087, the disclosure of which is herein incorporated by reference).

FIG. 9 shows the spectrum of an ultra-high Ra white LED (UHR-white), with a T_{cp} of 5000 K. Intensity in arbitrary units is shown along the vertical axis and Wavelength (nm) is shown along the horizontal axis. The spectra of a CIE Standard Illuminates (D50) and a conventional white LED (T_{cp}=5000 K), fabricated using only YAG phosphor, are also shown in FIG. 9. In UHR-white, the amount of luminescence in the blue-green and red regions was significantly enhanced compared with a conventional white LED. As a result, spectra of the high-Ra white LED were very similar to that of D50. Ra and CRI-No. 9 of the UHR-white were 97 and 96, respectively. Thus the color reproduction of this white LED was the highest of all white light sources.

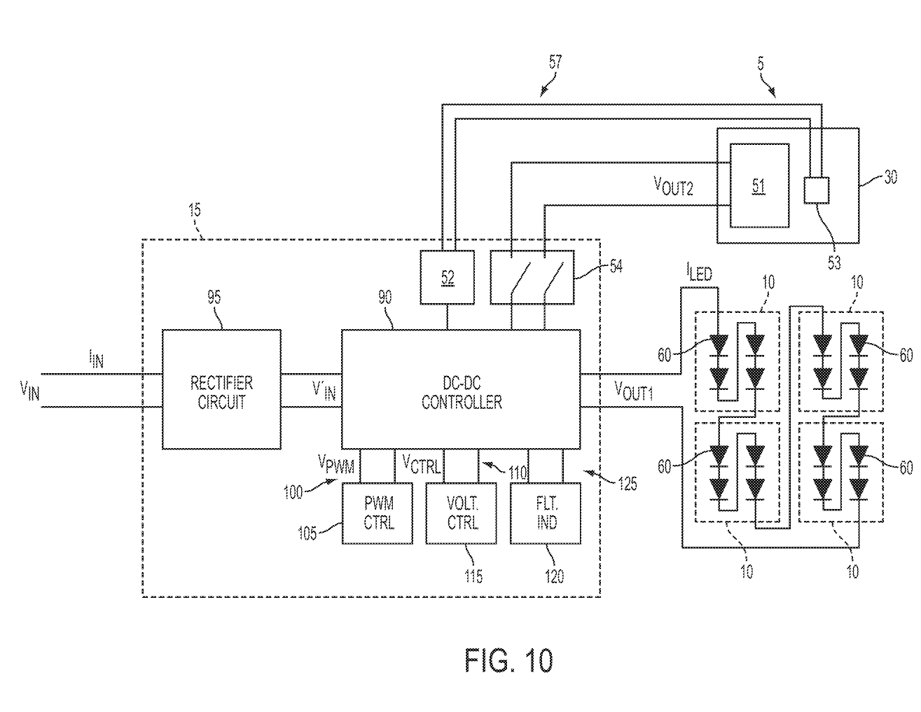

FIG. 10 is a block diagram of the LED arrays 10 and controller circuit 15 of FIG. 3 according to one embodiment. In various embodiments, the LED array 10 may comprise an LED 60 described in connection with FIGS. 5A-5B and 10 or the LED lamp 11 described in connection with FIGS. 7-8, without limitation. During operation of the anti-icing lamp assembly 5, the controller circuit 15 functions as a current source to supply operating power to the LED arrays 10 in the form of an output voltage V_{OUT1} and an output current I_{LED}. In certain embodiments and as discussed above, the lamp assembly 5 may comprise four LED arrays 10, with each LED array 10 comprising four LEDs 60. In the embodiment of FIG. 10, the LED arrays 10 and the LEDs 60 in each LED array 10 are connected in a series configuration to define a 16-LED string. Because the LED arrays 10 require constant current to produce a light output having a constant brightness, the controller circuit 15 may comprise a DC-DC controller 90, such as a DC-DC switching controller, operating as a constant current source. In certain embodiments, the DC-DC controller 90 may be implemented using a commercially available DC-DC switching controller package, such as the LT3755 DC-DC switching controller available from Linear Technology, Milpitas, Calif.

In certain embodiments, the controller circuit 15 may be configured for bipolar operation to ensure that an operating voltage of proper polarity is applied to inputs of the DC-DC controller 90 irrespective of the polarity of the input voltage V_{IN} applied to inputs of the controller circuit 15. In one embodiment, for example, the controller circuit 15 may comprise a bridge rectification circuit 95 for receiving an input voltage V_{IN} at either polarity and outputting a voltage of constant polarity to serve as the operating voltage of the DC-DC controller 90 (V′_{IN}). The bridge rectification circuit 95 may comprise, for example, four diodes connected in a bridge rectifier configuration. In certain embodiments, the diodes of the bridge rectification circuit 95 may comprise relatively low voltage drops (i.e., Schottky diodes) such that power consumption of the circuit 95 is reduced, although it will be appreciated that other types of diodes may be used instead. The bridge rectification circuit 95 thus ensures that an operating voltage V′_{IN} of proper polarity is applied to the DC-DC controller 90 regardless of the polarity of the input voltage V_{IN} applied to the controller circuit 15, thereby simplifying installation of the anti-icing lamp assembly 5 and protecting against component damage that might otherwise result from a reversed polarity of the input voltage V_{IN}.

In certain cases, and especially those in which the LED arrays 10 and LEDs 60 are connected in a series configuration, the forward voltage required to drive the LEDs 60 may exceed an available input voltage V_{IN}. For example, the forward voltage required to drive the 16-LED chain of FIG. 6 may range from about 45 to 70 VDC, while the nominal value of the input voltage V_{IN} may be approximately 14 or 28 VDC (e.g., in the case of aircraft lighting applications). Accordingly, in certain embodiments, the DC-DC controller 90 may be configured to operate in a boost mode whereby the output voltage V_{OUT1} of the controller circuit 15 is suitably increased above the operating voltage V′_{IN} supplied to inputs of the DC-DC controller 90 via the bridge rectification circuit 95 (e.g., approximately 14 or 28 VDC) such that the output voltage V_{OUT} satisfies the forward voltage requirements of the LEDs 60 (e.g., 45 to 70 VDC). In order to accommodate unexpected fluctuations of V_{IN} from its nominal value, the controller circuit 15 may be configured to maintain a suitable output voltage V_{OUT1} over a range of input voltage V_{IN} values. In one embodiment, for example, the controller Circuit 15 may be designed to generate a suitable output voltage V_{OUT1} based on nominal input voltages of 14 or 28 VDC, but may nonetheless maintain a suitable output voltage V_{OUT1} for input voltages V_{IN} within a range of approximately 4.5 to 40 VDC. It will be appreciated that the values of V_{IN} and V_{OUT1} described above are provided by way of example only, and that embodiments of the controller circuit 15 may generally be configured to operate using different values of V_{IN} and V_{OUT} based on, among other things, available input voltages V_{IN}, the number of LED arrays 10, the number of LEDs 60 in each array, and the manner in which the LED arrays 10/LEDs 60 are connected (e.g., series configuration, parallel configuration, or a combination thereof). According to various embodiments, for example, the DC-DC controller 90 may be configured to operate in a buck mode (e.g., in cases in which the forward voltage required to drive the LED arrays 10 is less than V_{IN}) or in a buck-boost mode (e.g., in cases in which V_{IN} may initially be larger than the forward voltage required to drive the LED arrays 10 but subsequently decreases below the required forward voltage, such as may occur in battery-powered LED applications).

According to various embodiments, the controller circuit 15 may comprise at least one control input for receiving a signal to selectively control the amount of current I_{LED} in the LEDs 60, thus enabling dimmability of the LEDs 60. In certain embodiments, such as those in which the DC-DC controller 90 is implemented using the LT3755 DC-DC switching controller, for example, the DC-DC controller 90 may comprise a first control input 100 to receive a pulse-width modulated (PWM) waveform (e.g., V_{PWM} in FIG. 10) to control a switch duty cycle of the DC-DC controller 90 such that the output current I_{LED} may be modulated substantially between zero and full current based on a PWM dimming ratio of the PWM waveform. The PWM dimming ratio may be calculated as the ratio of the maximum PWM period to the minimum PWM pulse width and may have a maximum value of 1500:1, for example. In certain embodiments and as shown in FIG. 6, the controller circuit 15 may comprise a PWM controller 105 for outputting a user-controllable (e.g., using a potentiometer or jumpers coupled to the PWM controller 105) PWM waveform to the first control input 100 of the DC-DC controller 90. In other embodiments, the PWM waveform may be supplied from a user-controllable PWM waveform source external to the anti-icing lamp assembly 5.

In addition or as an alternative to the use of a PWM waveform to control output current I_{LED} via a first control input 100, certain embodiments of the controller circuit 15, such as those in which the DC-DC controller 90 is implemented using the LT3755 DC-DC switching controller, for example, may comprise a second control input 110 to control the amount of current I_{LED} in the LEDs 60 based on DC voltage signal V_{CTRL} applied to the second control input 110. For example, when V_{CTRL} is maintained above a threshold value (e.g., 1.1 VDC), the current I_{LED} may be dictated by the combined resistances R_{LED} of the LEDs 60, e.g., I_{LED} is about 100 mV/R_{LED}. When V_{CTRL} is reduced below the threshold value, the current I_{LED} may be dictated by the values of both R_{LED} and V_{CTRL}, e.g., I_{LED} is about (V_{CTRL}−100 mV)/R_{LED}. In accordance with this example, for a threshold value of 1.1 VDC, the current I_{LED} may be varied substantially between zero and full current by suitably varying V_{CTRL} between about 100 mVDC and about 1.1 VDC, respectively. In certain embodiments, the controller circuit 15 may comprise a voltage controller 115 for deriving a value of V_{CTRL} from another voltage present within the controller circuit 15 (e.g., V_{IN}). In one embodiment, for example, the voltage controller 115 may be implemented using a potentiometer to enable manual adjustment of V_{CTRL}, and thus I_{LED}, by a user. In another embodiment, voltage controller 115 may be implemented using a thermistor to automatically adjust V_{CTRL} based on a temperature sensed within the lamp assembly 5 (FIG. 7B). For example, an NTC (negative temperature coefficient) thermistor may be coupled to the second control input 110 such that decreasing thermistor resistance (indicative of increasing temperature) causes V_{CTRL} to decrease, thus decreasing I_{LED}. Conversely, increasing thermistor resistance (indicative of decreasing temperature) may cause V_{CTRL}, to increase, thus increasing I_{LED}. In this way, if a temperature within the anti-icing lamp assembly 5 becomes excessive due to, for example, environmental conditions, the controller circuit 15 may compensate by reducing the output current L_{ED} to reduce the amount of heat dissipated by the LED arrays 10 and controller circuit 15, thus maintaining the reliability and operating lifetime of the anti-icing lamp assembly 5.

In embodiments in which the LED arrays 10 and LEDs 60 are connected in a series configuration, such as that of FIG. 10, it will be appreciated that failure of a single LED 60 may cause the failure of the entire LED chain if, for example, the LED fails in an open circuit mode. Accordingly, a failure of the LED chain due to an open LED mimics the failure of an incandescent filament. In order to provide a positive confirmation that a lack of output light is due to an open LED, the controller circuit 15 may comprise a fault indicator 120 to indicate the existence of this condition. In certain embodiments of the controller circuit 15, such as those in which the DC-DC controller 90 is implemented using the LT3755 DC-DC controller, for example, the DC-DC controller 90 may comprise an open LED output 125 (e.g., an open-drain status output) that electrically transitions (e.g., pulls low) when an open LED fault is detected by the DC-DC controller 90. The transition of the open LED output 125 may be used to control operation of the fault indicator 120. In one embodiment, for example, the transition of the open LED output 125 may cause a driver circuit (not shown) of the controller circuit 15 to energize a low-power LED of the fault indicator 120 that is visible through the lens array 20 and cover 30 to provide a visual indication of the open LED fault. In another embodiment, the fault indicator 120 may not be a component of the anti-icing lamp assembly 5 and instead may be located remotely therefrom, such as on a dashboard or display that is visible to an operator.

According to various embodiments, the DC-DC controller 90 may be configured to turn off when the input voltage V_{IN} of the controller circuit 15 (or the input voltage V′_{IN} of the DC-DC controller 90) falls below a pre-determined turn-off threshold and to subsequently resume operation when the input voltage V_{IN} rises above a pre-determined turn-on threshold. In one embodiment, for example, although it may be feasible to operate the controller circuit 15 using input voltage V_{IN} in a range of approximately 4.5 to 40 VDC, the controller circuit 15 may nonetheless be configured to turn off when the input voltage V_{IN} falls below 10 VDC (turn-off threshold), for example, and to subsequently resume operation when the input voltage V_{IN} rises to a pre-determined value above the turn-off threshold, such as 10.5 VDC (turn-on threshold), for example. In certain embodiments of the controller circuit 15, such as those in which the DC-DC controller 90 is implemented using the LT3755 DC-DC switching controller, for example, the turn-off and turn-on thresholds may be programmed using an external resistor divider connected to a shutdown/undervoltage control input of the DC-DC controller 90. In this way, when the voltage of the electrical power system falls below a pre-determined value (due to an electrical malfunction or low battery charge, for example), the electrical load represented by the DC-DC controller 90 and the LEDs 60 may be removed from the electrical power system.

Additional details of one embodiment of the controller circuit 15 for driving the LED array 10 is described in commonly assigned U.S. Patent Application Publication No. 2011/0043120 to Panagotacos et al and entitled “Lamp Assembly,” the disclosure of which is incorporated herein by reference. It will be appreciated that, in one embodiment, the controller circuit 15 may be used and/or configured to drive the phosphor-conversion white LED lamp 11 shown in FIGS. 6-7.

In one embodiment, the controller circuit 15 may comprise a control circuit 52 for controlling the defroster elements 51 of the lamp assembly 5. Embodiments of defroster elements 51 include, without limitation, transparent electrically conductive coatings for glass substrates, resistive conductive elements for transparent substrates, exothermic deicing thermal energy systems, infrared thermal energy sources, heat sink thermal energy transfer systems, among others. In one embodiment, the control circuit 52 is configured to operate a switch 54 at an output portion of the DC-DC controller 90 in order to apply a voltage V_{OUT2} to the defroster element. Based on the type of defroster element 51 employed, the voltage V_{OUT2} may be employed directly to heat the cover 30 of the lamp assembly 5 or may used as a control signal to operate other devices, such as a pump, for example. In one embodiment, a feedback element 53 may be provided on the cover 30 to provide a feedback signal 57 to the control circuit 52. In various embodiments, the feedback element 53 may be any type of sensor capable of detecting condensation, fog, ice, rime, frost, and/or snow that may develop on the clear cover 30 and/or temperature of the clear cover 30. In operation, the control circuit 52 activates the output switch 54 to couple V_{OUT2} to the defroster element 53 in response to the feedback signal 57. Examples of defroster elements 51 and feedback elements 53 are described hereinbelow. It will be appreciated that the controlling the defroster elements 51 and feedback elements 53 using conventional circuits is within the knowledge of one skilled in the art.

FIGS. 11A, 11B, and 11C are front, back and perspective side views, respectively, of the base 25 of FIG. 3. The base 25 may be generally circular in shape when viewed from the front and back and comprise a front surface 195 to receive the LED arrays 10 and controller circuit 15 (e.g., via the substrate 40) and the lens array 20. The base 25 may also comprise a back surface 200 opposite the front surface 195 that is structured to be removably received by a lamp holder, such as, for example, an incandescent lamp holder. To maintain a suitable temperature of the anti-icing lamp assembly 5 during its operation, the base 25 may be configured to receive and dissipate heat generated by the LED arrays 10 and controller circuit 15. The base 25 may therefore comprise a material having a suitably high thermal conductively, such as, for example, aluminum or copper. It will be appreciated, however, that the base 25 may additionally or alternatively comprise other materials, such as thermoplastic, for example. In certain embodiments, the base 25 may be formed as a single element using, for example, a die casting or injection molding process. The front surface 195 may be generally planar and define a number of openings 205 to retain fasteners (e.g., screws) for attaching the LED arrays 10, the controller circuit 15 and the lens array 20 to the front surface 195. The base 25 may additionally comprise a lip 210 disposed about a periphery of the front surface 195 to receive the cover 30. The lip 210 may define a number of openings 215 to retain fasteners (e.g., screws) for attaching the cover 30 to the lip 210. The lip 210 may additionally define a groove 220 to receive a gasket 225 (FIG. 3), such as, for example, an elastomeric O-ring gasket. In the assembled state of the anti-icing lamp assembly 5, the gasket 225 be disposed between and compressed by the cover 30 and the base 25 to form a weather-tight barrier between the cover 30 and the base 25.

With reference to FIG. 11C, the back surface 200 of the base 25 may comprise a generally outward-curving geometry, such as, for example, a circular paraboloid geometry, that is suitably dimensioned for removable receipt by a lamp holder designed to accommodate a lamp having a standard shape and size. In certain embodiments, for example, the back surface 200 may be dimensioned for removable receipt by a conventional incandescent lamp holder designed to accommodate a parabolic aluminum reflector (PAR) lamp, such as, for example, a PAR-36 lamp, a PAR-56 lamp or a PAR-64 lamp. The back surface 200 may also define a collar 230 disposed about a periphery of the back surface 200 adjacent the lip 210, at least a portion of which is configured for removable engagement by a corresponding portion of the lamp holder when the anti-icing lamp assembly 5 is received therein. In certain embodiments, the engaged portion of the collar 230 may be suitably smooth to provide a weather-tight seal between the collar 230 and an opposing gasket of the lamp holder. The back surface 200 may additionally define a key 235 adjacent the collar 230 to be removably received into a corresponding slot of the lamp holder, thereby ensuring proper rotational alignment of the anti-icing lamp assembly 5 with the lamp holder.

In certain embodiments and as shown in FIGS. 11B and 11C, the front and back surfaces 195, 200 may define a plurality of close-ended openings 240 that substantially increase the surface area of the surfaces 195, 200. The collective surfaces of the openings 240 thus provide a cooling structure to increase the heat-dissipative properties of the base 25.

As shown in FIGS. 11A and 11B, the base 25 may define a set of apertures 245 extending between and connecting the front and back surfaces 195, 200 of the base 25 in order to accommodate the set of electrical connectors 36 of the anti-icing lamp assembly 5 (FIG. 3). The apertures 245 may be located such that, in the assembled state of the anti-icing lamp assembly 5, openings of the apertures 245 on the front surface 195 are respectively aligned with electrical input connection points (e.g., openings 55) of the substrate 40. Additionally, openings of the apertures 245 may define a non-circular shape (e.g., a hexagon) to prevent rotation of similarly-shaped electrical connectors 36 within the apertures 245.

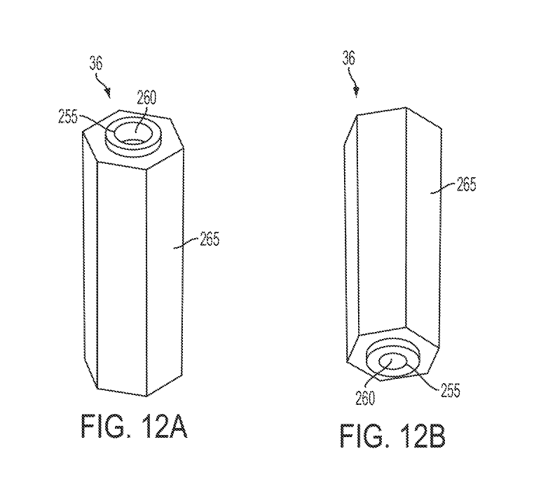

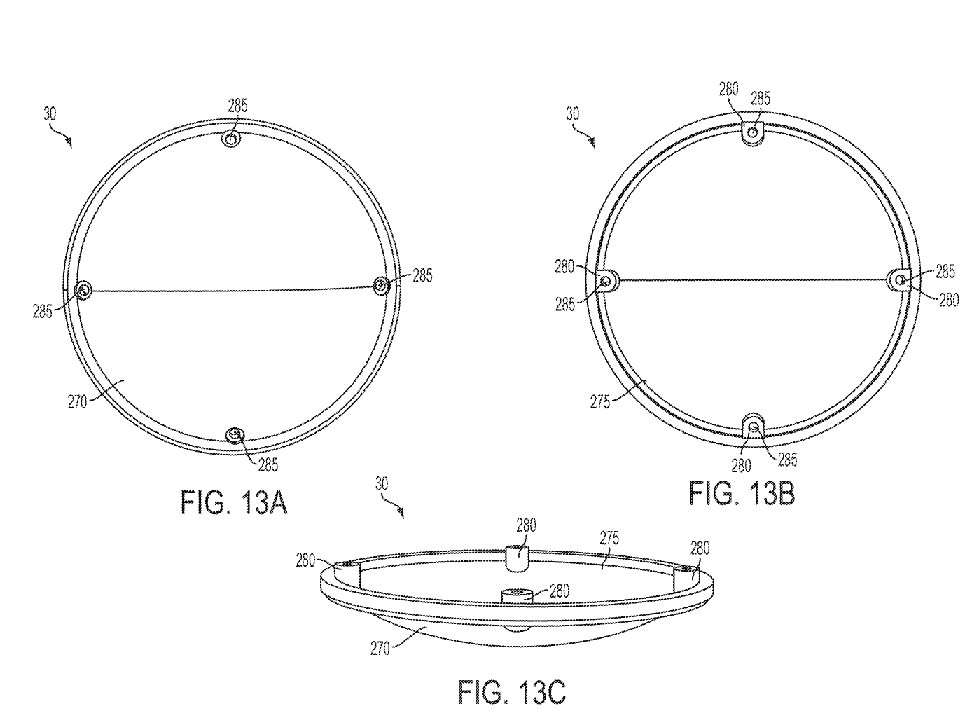

FIGS. 12A and 12B are perspective views of one of the set of electrical connectors 36 of the anti-icing lamp assembly 5 according to one embodiment. Each connector 36 may comprise a conductor 255 in the form of metal rod defining an opening 260 at each end configured to retain a fastening member (e.g., a screw). The connector 36 may further comprise an electrical insulator 265 (e.g., a nylon resin) formed on an exterior surface of the conductor 255 such that each end of the conductor 255 and its respective opening 260 are the only exposed portions of the conductor 255. The electrical insulator 265 may define a shape that conforms to the shape of the apertures 245 defined by the base 25. For example, as shown in FIGS. 8A and 8B, the electrical insulator 265 may define a hexagonal shape that conforms to the hexagonal shape of the apertures 245 of FIGS. 7A and 7B.

In the assembled state of the anti-icing lamp assembly 5 and with reference to FIG. 2, the electrical connectors 36 may respectively extend through the apertures 245 of the base 25, with a first end of each connector 36 being electrically coupled to the controller circuit 15 by, for example, a fastener (e.g., screw, bolt, rivet, snap) that extends through a corresponding opening 55 of the substrate 40 to be retained in an opening 260 of the electrical connector 36. In this manner, the first end of each electrical connector 36 may be electrically coupled to the controller circuit 15 via the conductive periphery of the openings 55. A second end of each electrical connector 36 may be accessible from the back surface 200 of the base 25 and be electrically connected to an electrical power system external to the anti-icing lamp assembly 5 using, for example, a fastener (e.g., a screw, bolt, rivet, snap) retained in an opening 260 of the electrical connector 36. As will be appreciated from FIG. 2, the conductor 255 of each electrical connector 36 is electrically insulated from the base 25 by virtue of the electrical insulator 265 formed on the exterior surface of the conductor 255. In certain embodiments, a sealant and/or adhesive material may be disposed between each electrical insulator 265 and the inner surface of its corresponding aperture 245 to provide a weather-tight barrier between the electrical connectors 36 and the base 25 and/or to ensure a suitably strong mechanical bond therebetween.

FIGS. 13A, 13B, and 13C are front, back and perspective side views, respectively, of the cover 30 of FIG. 3. As shown, the cover 30 may be in the general shape of a disc and comprise a convex front surface 270 and a concave back surface 275. It will be appreciated that one or more of the surfaces 270, 275 may alternatively comprise another suitable surface profile, such as a flat profile, for example. The cover 30 may be integrally formed from a suitably light-transmissive material, such as a clear polycarbonate material, for example. A diameter of the cover 30 may be such that, in the assembled state of the anti-icing lamp assembly 5, a peripheral portion of the back surface 275 opposes the lip 210 of the base 25. As discussed above, the gasket 225 may be disposed between and compressed by the cover 30 and the base 25, thereby forming a weather-tight barrier therebetween. With reference to FIG. 12C, the cover 30 may comprise standoffs 280 formed on a periphery of the back surface 275 that correspond in number to the openings 215 of the lip 210. Each standoff 280 may define an opening 285 therethrough that, in the assembled state of the anti-icing lamp assembly 5, aligns with a corresponding opening 215 of the lip 210. The cover 30 may thus be attached to the base 25 using, for example, a faster (e.g., a screw, bolt, rivet, snap) that extends through each opening 285 from the front surface 270 to be retained in the corresponding opening 215 of the lip 210.

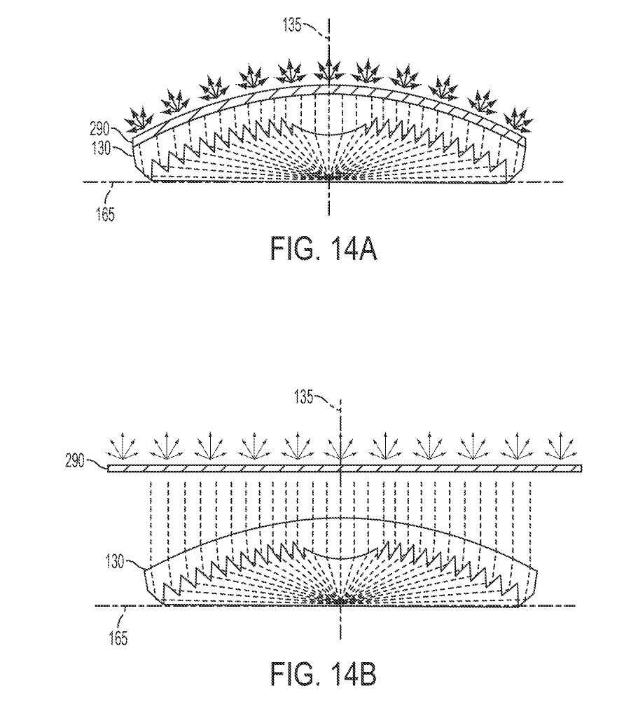

According to various embodiments, the lamp assembly 130 may comprise one or more diffuser optics for modifying a distribution of light emitted by the TIR lens 130. In certain embodiments, a diffuser optic may be formed on the surface of the exit face (not shown) of each TIR lens 130, as shown in FIG. 14A, or on a surface of the cover 30. In other embodiments, diffuser optics may be formed as separate elements. As shown in FIG. 14B, for example, diffuser optic 290 may be formed as an element that is separate from the TIR lenses 130. The diffuser optic(s) 290 may be configured to shape light emitted from the TIR lens 130 to conform to a particular shape or a predetermined field-of-view. As shown in FIGS. 14A and 14B, for example, diffuser optics 290 operate to spread the light distributed from the exit face 180 of the TIR lens 130, thus increasing the angular spectrum of illumination. In certain embodiments, the diffuser optic(s) 290 may be implemented using a diffuse glass or plastic. In other embodiments, the diffuser optics(s) 290 may be implemented using a holographic diffuser, otherwise known as a kinoform diffuser. Examples of holographic diffusers are described in “An Overview of LED Applications for General Illumination” (Conference Proceedings Paper), David G. Pelka, Kavita Patel, SPIE Vol. 5186, November 2003; and “Keen Forms of Kinoforms—Kinoform-based Diffusers Help Lighting Designers Leverage Unique LED Advantages,” David G. Pelka, OE Magazine, Vol. 3 No. 10, p. 19, October 2003, both of which are incorporated herein by reference. In other embodiments, the diffuser optic(s) 290 may be formed using microlens arrays comprising multiple lenses formed in a two-dimensional array on a supporting substrate, such as those manufactured by Rochester Photonics Corp., Rochester, N.Y.

LEDs by their very nature are extremely small, an almost perfect thermodynamic light source, and are easily integrated with optical systems. The ability of any optical system to gather up the light from any source is directly proportional to the size of the optical system relative to the size of light source. Consequently LEDs enjoy a fundamental advantage over incandescent lamps, fluorescent lamps, and high-intensity discharge sources because of LEDs' intrinsically small size and the fact that they do not require a large glass envelope as many of their competitive light sources do.

Optics can broadly be broken down into the two fields of imaging and non-imaging optics. Imaging optics has been around for well over 300 years and is the optics of parabolas, ellipses, thick lenses, thin lenses and Fresnel lenses. The one characteristic that all of these optical technologies have in common is that they form images of objects (see FIG. 3) and are frequently used in such things as cameras, movie and 35 mm slide projectors, automobile headlights, flashlights, eyeglasses, etc. As the lighting industry developed over the past 200 years it was natural to incorporate this already existing imaging optical technology into new lighting systems. However, a little thought experiment will show that imaging optics is far from optimum. Consider for the moment the simple example of a parabola used in a flashlight to project a beam. Depending upon the depth of the parabola, only about 40% of the light leaving the light bulb will reflect off the parabolic mirror be collimated and projected into the beam. The other 60% of the light leaves the flashlight in an unguided way and is typically not useful and in many applications considered a negative attribute known as glare. This is particularly true for automobile headlights. It is obvious that the optimum optical system should completely surround the source, gathering up every photon leaving the source and delivering those photons into a prescribed field of view or flux pattern, regardless of whether an image is formed or not. This is exactly what the field of non-imaging optics seeks to do as shown in FIG. 8.

The field of non-imaging optics relaxes the constraint that an image be formed and in so doing allows the resulting optical system to be both much more efficient and compact than imaging optical systems. The field of non-imaging optics first got its start in the United States in the 1930s and '40s at lighting companies such as General Electric. However, it was not until the 1970s when Roland Winston (W. T. Welford, R. Winston, The Optics of Nonimaging Concentrators, Academic Press, New York, 1978 and W. T. Welford, R. Winston, High Collection Nonimaging Optics, Academic Press, New York, 1989, the disclosure of each is herein incorporated by reference) of the Physics Department of the University of Chicago and W. T. Welford of the Physics Department of University of London, began formulating the principles, theory and mathematics of non-imaging optics that the field began to gain recognition. One of its first applications was to the field of solar energy concentration for both photovoltaic and solar thermal systems. Subsequently, applications such as fiber-optic couplers, backlights for liquid crystal displays, and sensors for high-energy particle physics all came to benefit from the increased optical efficiency and compactness that non-imaging optics could supply. In fact, it is not unusual for non imaging optics to have increased efficiencies from 50%-150% over corresponding imaging optical systems and at the same time to be a much more compact, typically 4 to 12 times more compact, than the corresponding imaging optical system it replaces.

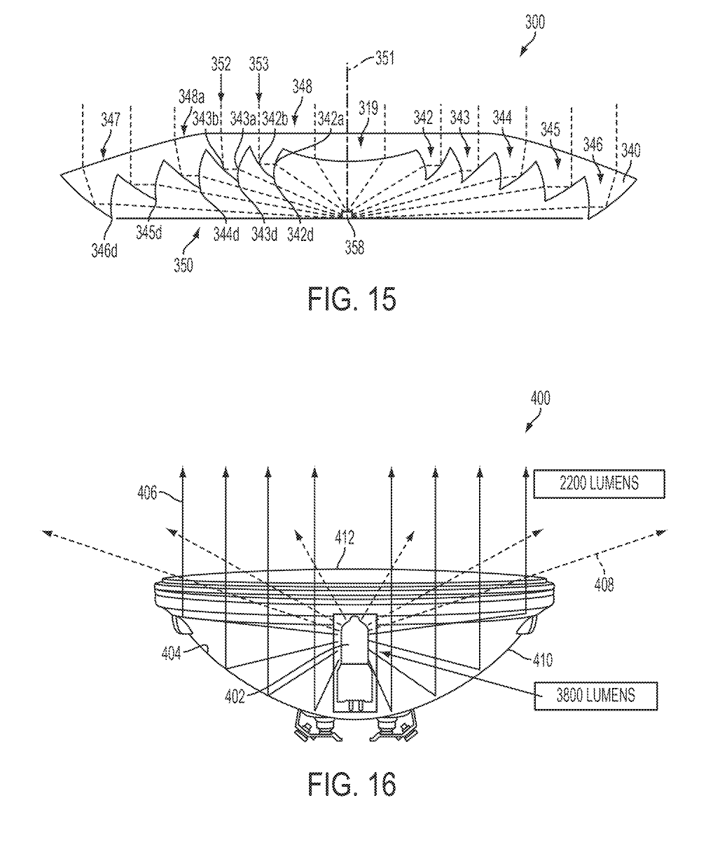

FIG. 15 is a cross-sectional view of a non-imaging lens called a total internal reflection (TIR) lens 300, according to one embodiment. A radiant energy redirecting system may comprise a radiant energy transmitting body structure, where the structure comprises multiple elements, each of which acts as a radiant energy redirecting module, having on its cross-sectional perimeter an entry face to receive incidence of the energy into the interior of the perimeter, an exit face to pass the energy to the exterior of the perimeter in a direction towards the reverse side of the body from the side of the incidence. A TIR face angled relative to the entry and exit faces to redirect towards the exit face the radiant energy incident from the entry face. The body structure generally redirecting incident radiant energy towards a predetermined target zone situated apart from and on the reverse side of the body relative to the side of the incidence. The lens structure associated with at least one of the faces for redirecting radiant energy passing between the entry and exit faces via a TIR face.

As shown in FIG. 15, the axis of the annular, radiant energy transmitting body 340 appears at 351. The body has multiple annular facets 342 to 346 which are generally concentrically arranged, but having tips 342d to 346d progressively closer to plane 350 normal to axis 351. The face 342a of the facet 342 is convex toward face 342b; and the face 342b is concave toward the face 342a in the section shown. This relationship obtains for other facets, as shown. An LED 358 is located at the intersection of plane 350 with axis 351 and emits light rays toward the body 340. A ray 353 passes through the face 342a, is refracted toward the TIR face 342b and is reflected toward and passes through the upper flat face 348. See also the ray 352 passing through the face 343a, reflecting at the TIR face 343b, and passing through the upper face 348a, angled as shown. All rays passing upwardly beyond the faces 348 and 348a are collimated. The transverse width of the body 340 may be from about 0.12 to about one inch, for example, and the transparent body 340 may consist of molded plastic material. A refractive section without facets appears at 319. Smaller ratios of lens diameter to LED size may have outermost facets large, and successively inward facets smaller, in order to have a higher lens profile and better collimation curved facets are necessary for.

The TIR lens 300 captures almost 100% of the light leaving the LED light source and yet has an f #<0.25. Recall that the definition of the f # of a lens is the ratio of its focal length divided by the aperture (diameter) of the lens. Imaging lenses typically have f #s in the range of 1 to 5, which implies that they are of 4 times to 20 times less compact than the TIR lens. The LED source located at the point 358 and emits in a hemispherical pattern and there is refraction at the entry face of the TIR facet as with the ray 345 and total internal reflection at the back of the facet, followed by refraction as the ray exits the top of the lens in a collimated series of rays. The TIR lens 300 is a combination of both an imaging and non-imaging lens. It is imaging in the most central part of the lens as the ray 319 illustrates, but all of the facets to the right and left of the central part of the TIR lens 300 are non-imaging in so far as the TIR face is a mirror which reverses left for right and thus eliminates the ability to form an image. Many times a TIR lens is confused with a Fresnel lens, which also has facets, but is an imaging lens and which only uses refraction on the entry and exit facets to form a beam and image of the source.

To understand the importance of completely surrounding the light source and the improved candlepower of the resulting lamp, we must undertake a direct comparison of the TIR lens 300 with the most common technology previously used for incandescent landing lights, that of the parabolic reflector. FIG. 16 shows an incandescent landing light 400 comprising a parabolic reflector 410. As shown in FIG. 16, of the approximate 3800 lumens emitted by the GE 4553 landing light lamp 402 that only 2200 lumens or about 42% of the emitted flux 406 (shown in solid line) actually strikes the reflector 404 and thus results in the directed beam 406. About 58% of the emitted flux 408 (shown in broken line) goes out and never strikes the reflector and for the most part results in unwanted glare. Similarly if one tries to use a lens or its thin lens equivalent, a Fresnel lens, only captures 20% (for an f#1 lens) of the light leaving a hemispherical source such as an LED, this stems from the solid angle that the lens subtends at the source. With reference now to both FIGS. 15 and 16, the TIR lens 300, on the other hand, gathers up all the light from the hemi-spherically emitting LED 358 source and puts that light into the beam. Now the optical efficiency of the parabolic reflector 410 and the TIR lens 300 are similar at about 80% each. For the parabolic reflector 410 this stems from the reflectance of the reflector being about 90% as well as a 90% transmission through the front glass window 412 is about 90% (Fresnel reflection losses of about 10% from the two glass interfaces), whereas the TIR lens 300 has scattering from the facet tips 342d-346d as well as Fresnel losses from the entrance and exit facet surfaces. Accordingly, the TIR lens 300 can create the same candlepower into the outgoing beam with about 50% of the input flux that the parabolic reflector requires. The TIR lens 300 has quite a significant advantage when using LEDs as the light source compared to parabolic reflectors or Fresnel lenses.

One of the issues frequently overlooked in beam forming is the uniformity in the beam cross section. By examining FIGS. 15 and 16, it can be seen that the intensity of the light striking the parabolic reflector 410 or the TIR lens 300 falls off as 1/R² as one moves away from the source lamp 402 0r LED 358 in accordance with the conservation of energy theory. If one imagines spheres surrounding the source of increasing radii R, then the intensity of the radiation must fall off as 1/R² as the area of the sphere is increasing as R². This results in non-uniformity of the beam of ratios of 4:1, in other words, the central region of the beam will be 4 times as intense as the outer region of the beam.

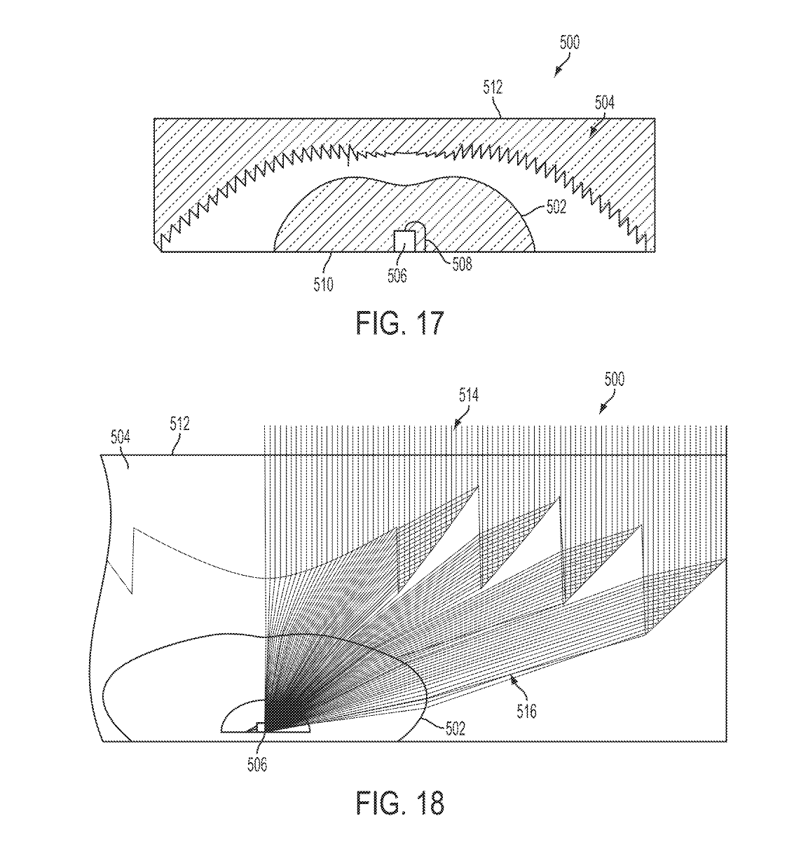

To overcome this defect, the TIR lens 300 uses a lens to purposely distort the intensity of the light leaving the LED 358 source, affectionately called a deviator (mushroom) lens 502 as shown in FIGS. 17 and 18, because of its mushroom like shape. The mushroom deviator lens 502 purposely sends more light to the far-reaches of the lens facets, thus homogenizing the overall beam pattern.

Light sources without envelopes, such as light emitting diodes (LEDs), can benefit from a mushroom-shaped light-deviating (deviator) lens 502 as shown in FIGS. 17 and 18. FIG. 17 shows one embodiment of an m-TIR lens 500 comprising a mushroom-shaped deviator lens 502 and a TIR lens 504. As shown in FIG. 17, an LED 506 light source, with typical power-delivery wire 508 and planar reflector 510, is embedded in the mushroom-shaped deviator lens 502. The mushroom-shaped deviator lens 502 is shaped to cause the TIR lens 504 to have uniform output at a light exit face 512. For the sake of accommodating differential thermal expansion from heat generated by the operation of the LED, the mushroom-shaped deviator lens 502 may be made of an elastomeric material such as optical-grade silicone. Since the LED 506 typically has the shape of a cube, their output is greater in the direction of the cube diagonal than in the direction perpendicular to the cube face. To compensate, the mushroom-shaped deviator lens 502 may have somewhat different cross sections in these two directions.

In summary, the mushroom-shaped deviator lens 502 is a powerful way to control the output of a TIR lens 504. Improved collimation is provided because the entire beam will have the same angular spread, resulting in improved beam propagation over conventional parabolic reflectors, which have very non-uniform output. This allows the use of holographic diffusers and lenticular lenslet arrays to produce tailored output intensity, because the uniform output 514 (FIG. 18) of the TIR lens 504 is useful to the use of these devices, which can be made integral with the output face 512 of the TIR lens 504. This enables compact LED 506 light sources with specifically tailored output to be available for a variety of applications, including the anti-icing lamp assembly 5 described herein.

FIG. 18 shows one embodiment of the mushroom-shaped deviator lens 502 shown in FIG. 17 in combination with the TIR lens 504 denoted as m-TIR lens 500 with computer generated ray tracing 516. As shown, by examining the computer generated ray tracing 516, it can be seen that almost perfect uniformity in the beam cross section as a result of the mushroom-shaped deviator lens 502 pre-distortion of the light leaving the LED light source 506.

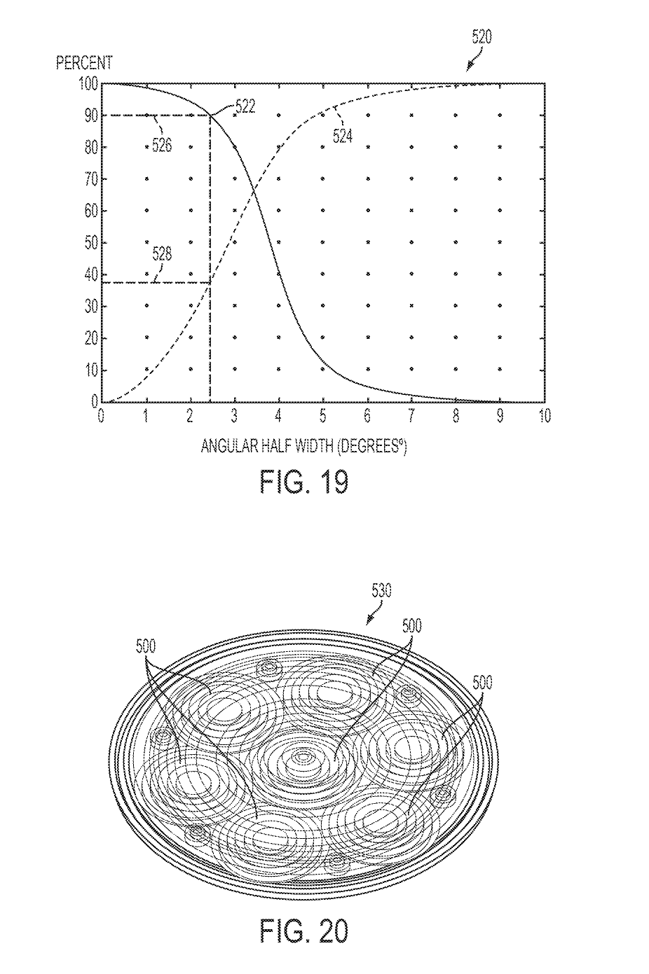

A modeled performance of an m-TIR LED based lamp (e.g., a lamp employing the m-TIR lens 500 shown in FIGS. 17 and 18) versus a GE Par 46 model 4553 parabolic reflector lamp. To put many of these above noted features of the m-TIR lens 500 assembly into a practical setting, let us consider how we would expect the m-TIR LED lamp to compare to a typical taxi light used in large commercial aircraft, for example, the GE PAR 46 model 4553 parabolic reflector lamp. The LED-chosen for the source is a Cree XM-L LED powered at 3,000 mA and 3.6 Vdc (10.8 watts) which produces a total of 698 lumens out of the LED source as measured in the integrating sphere in Teledyne's Micro-Electronics Photonic Laboratory. Recall that the TIR lens 504 will allow about 82% of this light into the beam, thus 572 lumens into the total beam. Now the computer modeled performance of the m-TIR lens 500 combination as shown in FIG. 18 is given by the computer modeled curves 520 in FIG. 19. FIG. 19 is a computer modeled performance of an m-TIR lens assembly where the solid line 522 is the relative intensity for degrees off-axis and the dotted line 524 is cumulative. Percentage is shown along the vertical axis and angular half width in degrees is shown along the horizontal axis. From FIG. 19 the maximum beam candlepower defined as the lumens per steradian at the 90% point of the intensity curve 528 can be calculated. The 90% curve shows that the angular half width is 2.42° while the cumulative flux 528 associated with that angular width is 38%. So our computer modeled candlepower is:

I=0.38×572 lumens/Ω, where Ω the solid angle subtended=2π(1−cos 2.42°=0.0056 str.

I=38,814 cd (candel power).

FIG. 20 illustrates a lamp assembly comprising a plurality of m-TIR lenses 500 according to one embodiment. As shown in FIG. 20, seven m-TIR lens 500 assemblies can fit in a GE Par 46 model 4553 parabolic reflector lamp assembly 530. Accordingly, a total candle power of approximately Iₜₒₜₐₗ=7×38,814=271,700 candle power can be expected.

From GE's specification sheet, the model 4553 PAR 46 lamp assembly with a conventional lamp (e.g., lamp 402 FIG. 16) should produce 300,000 maximum beam candlepower at 28V while consuming 250 watts.

The Cree XM-L LED is currently rated at 100 lumens/watt when powered at 1500 mA and 3.0 Vdc, with 150 lumen/watt expected to be available in the market over the next 12-18 months. Even with today's LED rating, however, Teledyne Micro-Electronics modeled m-TIR LED lamp comes within 10% of the performance of the GE PAR lamps for large aircraft. If one considers that the Teledyne LED lamp consumes approximately 175 watts less power (75.6 watts vs. 250 watts), while the GE lamp is rated at a nominal 25 hr lifetime while the LED lamp should have a rated lifetime of a minimum of 10,000 his and perhaps as much as 30,000 hrs. This implies drastically less maintenance for the airline companies and corresponding dramatic cost savings. In addition, pilot's visual acuity is expected to be enhanced as a result of their night time scotopic vision being better aligned with the bluer light emitted by LED light sources as compared to the incandescent or halogen based lamps. Thus, LED lamps with sophisticated optics like Teledyne Micro-Electronics has proposed make a compelling story, indeed, and should come to replace all the incandescent and halogen based lamps used in the aircraft industry over the near future.

Having described one embodiment of an anti-icing lamp assembly 5 generally, the description now turns to various embodiments of defroster elements that can be adapted and configured to operate with various embodiments of the anti-icing lamp assembly 5. The defroster elements embodiments include, among others, transparent electrically conductive coatings for glass substrates, resistive conductive elements for transparent substrates, exothermic deicing thermal energy systems, infrared thermal energy sources, heat sink thermal energy transfer systems. The operation of each of the defroster elements described hereinbelow may be controlled by various embodiments of a defroster controller circuit. In one embodiment, the defroster controller circuit may be incorporated into the controller circuit 15, whereas in other embodiments the defroster controller circuit may be separately implemented from the controller circuit 15. In various embodiments, the defroster controller circuit may be configured to receive an activation input or may receive a feedback control signal to automatically activate the defroster elements when temperatures fall below a predetermined temperature (e.g., 32° F.) or when sensed environmental conditions are conducive to condensation, fog, rime, frost, snow, or ice forming on the exterior surface of the cover. Examples of environmental conditions that may be monitored by the aircraft control system include outside temperature, wind speed, humidity, barometric pressure, aircraft speed, and the like. The scope of the present disclosure, however, is not limited in this context.

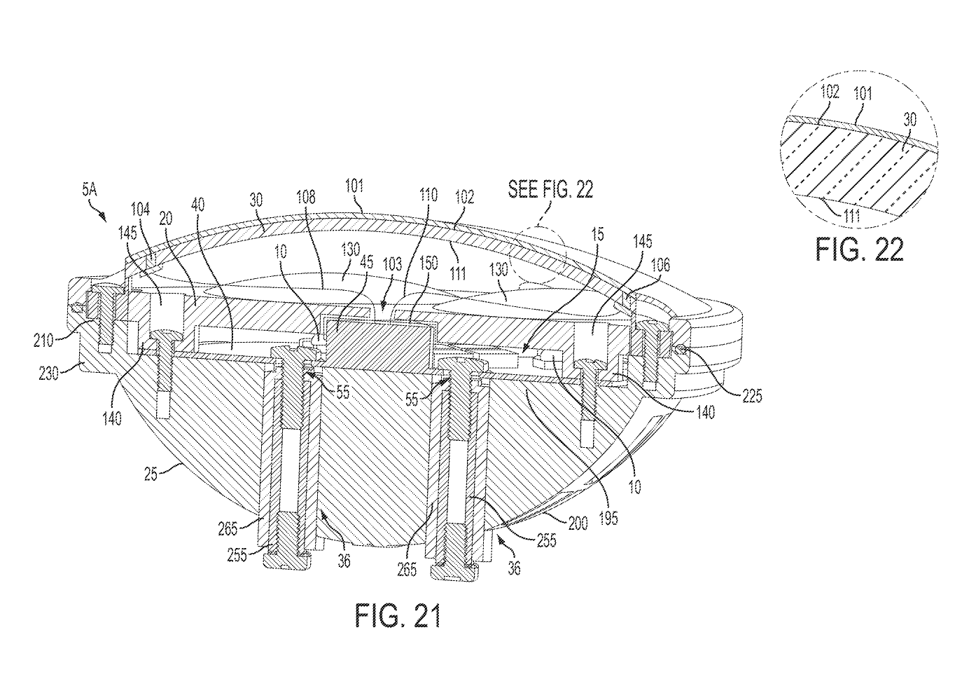

FIGS. 21, 22, and 23 illustrate an anti-icing lamp assembly 5A comprising a transparent electrically conductive coating according to one embodiment. In one embodiment, the anti-icing lamp assembly 5A comprises an optically transparent cover 30 comprising a substantially transparent electrically conductive coating 101 formed on the optically transparent cover 30. One type of electrically conductive coating 101 that may be applied to the glass cover 30 is known under the trade name “TEC Glass” available from Pilkington Specialty Glass Products of Toledo, Ohio. The transparent electrically conductive coating 101 formed on the glass cover 30 substrate is a thin pyrolytic film that can be directly electrically heated to clear or evaporate condensation or fog and thaw or deice rime, frost, snow, or ice that may develop on the clear cover 30 portion of the anti-icing lamp assembly 5A, for example. Those skilled in the art will appreciate that a pyrolytic coating is a thin film coating that can be applied at high temperatures and deposited onto a glass surface during a process known in the art as a float glass process, where a sheet of glass is made by floating molten glass on a bed of molten metal, typically Tin (Sn), although lead and various low melting point alloys have been used in practice. This method provides a uniform sheet thickness and very flat surfaces. The float glass process is also known as the Pilkington process, named after the British glass manufacturer Pilkington, which pioneered the technique. As shown more clearly in FIG. 22, the microscopically thin, durable pyrolytic film coating 101 can be applied to an exterior surface 102 of the glass cover 30 using chemical vapor deposition (CVD) processes, among other processes.

In one embodiment, the pyrolytic coating 101 is a tin oxide (SnO) coating applied to the exterior surface 102 of the glass cover 30 using a CVD process. In one embodiment, Indium-Tin-Oxide (InSnO) or Tin-doped Indium-Oxide can be used as the pyrolitic coating 101. Indium Tin Oxide (ITO, or Tin-doped Indium Oxide) may be formed of a solid solution of Indium(III) Oxide (In2O3) and Tin(IV) Oxide (SnO2), typically 90% In2O3, 10% SnO2 by weight. It is transparent and colorless in thin layers while in bulk form it is yellowish to grey. In the infrared region of the spectrum it acts as a metal-like mirror. Indium-Tin-Oxide is one of the most widely used transparent conducting oxides because of its two chief properties, its electrical conductivity and optical transparency, as well as the ease with which it can be deposited as a thin film. As with all transparent conducting films, a compromise must be made between conductivity and transparency, since increasing the thickness and increasing the concentration of charge carriers will increase the material's conductivity, but decrease its transparency. Thin films of Indium-Tin-Oxide are most commonly deposited on surfaces by electron beam evaporation, physical vapor deposition, or a range of sputter deposition techniques.

The Tin-Oxide (SnO) coating or Indium-Tin-Oxide coating may be applied in desired thicknesses to produce a visible transmission of light from about 80% to greater than about 90% and an electrical sheet resistance of about 6.0 to 8.0 Ohms/sq. (Ohms-per-square) to about greater than 250 Ohms/sq. Accordingly, an electrical current may be applied to the pyrolytic coating to generate heat and prevent ice from forming on the exterior surface 100 of the cover 30. Sheet resistance is a measure of resistance of thin films that are namely uniform in thickness. It is commonly used to characterize materials made by semiconductor doping, metal deposition, resistive paste printing, and glass coating. Examples of these processes include, without limitation, doped semiconductor regions (e.g., silicon or polysilicon), resistors screen printed onto the substrates of thick-film hybrid microcircuits, and the float glass process, among others.

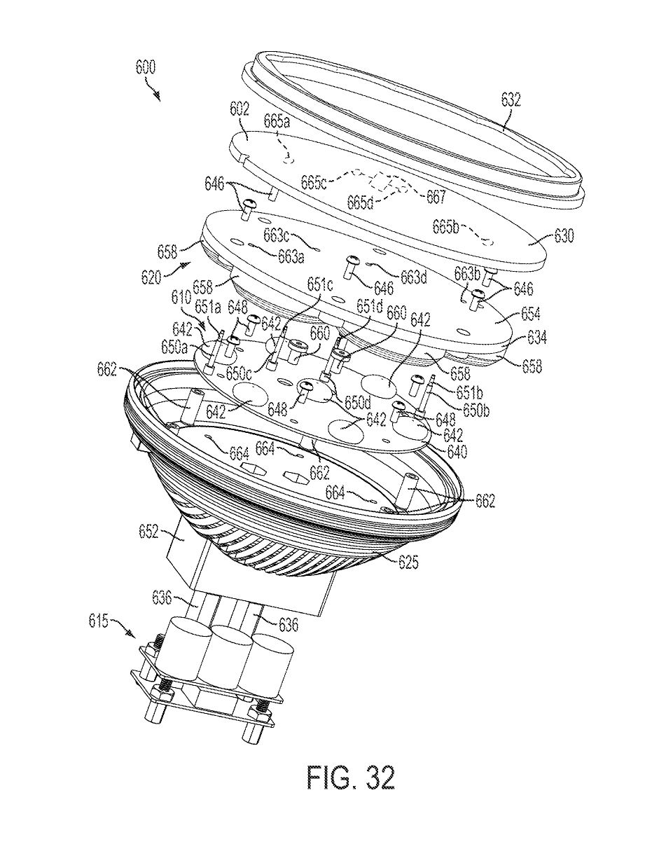

In one embodiment, a first pair of electrically conductive electrode pads 104, 106 may be formed on opposite sides of the exterior surface 102 of the cover 30. The controller circuit 15 is electrically coupled to the electrode pads 104, 016 through electrically conductive wires 108, 110 coupled to the substrate 40, or pogo pins as shown in connection with FIGS. 32-36, for example. The controller circuit 15 can apply a suitable electrical voltage and/or current can be applied to the electrode pads 104, 106 via the electrically conductive wires 108, 110. When a voltage is applied to the electrode pads 104, 106, an electrical current is generated through the resistive pyrolytic coating 101, which heats the cover 30 to evaporate condensation or fog and thaw frost, snow, or ice on the cover 30 of the lamp assembly 5A, for example. In the embodiment illustrated in FIGS. 21, 22, and 23, the electrical current conducted across the sheet resistance of the coating 101 heats the exterior surface 102 of the cover 30, thus minimizing the amount of energy required to heat the cover 30. In other embodiments, for completeness of disclosure, the coating 101 may be applied to an interior portion 111 of the cover 30. In such embodiment, the heat would be transferred through the glass substrate of the cover 30, which has poor thermal conduction properties.

In one embodiment, the electrode pads 104, 106 may be formed as electrically conductive bus bars. The bus bars may be screen printed onto opposing sides of an exterior or interior surface 102, 111 of the cover 30 prior to the application of the coating 101. The bus bars may be screen printed using electrically conductive inks or pastes, such as, for example, Palladium Silver, among other electrically conductive inks or pastes. In other embodiments, the bus bars may be formed of electrically conductive adhesive decals applied to the coating 101 and electrically coupled to the energy source via to the electrode pads 104, 106 and corresponding conductors 108, 110. In various embodiments, the electrically conductive adhesive decals may include conductive adhesives, inks, foil, tape, transfer tape, among others. The electrode pads 104, 106 are configured to receive an electrical voltage and/or current, which is converted to an electrical current through the sheet resistance of the coating 101. If the bus bars are formed on the interior surface 111 of the cover 30 an electrical connection may be provided to the coating 101 though the cover 30.

The electrically conductive wires 108, 110 are connected on one end thereof to the respective electrode pads 104, 106 and on another end are coupled to the energy source of the anti-icing lamp assembly 5A, which, in one embodiment, is the controller circuit 15 located on the substrate 40. In one embodiment, the electrically conductive wires 108, 110 may be connected to the electrode pads 104, 106 and/or the substrate using any suitable electrical connection such as, for example, solder, weld, crimp, clamp-type pressure connector, blade connectors, ring and spade connectors, slotted connectors, plug and socket connectors, terminal blocks, wire nuts, and the like. In one embodiment, the electrically conductive wires 108, 110 may be fed through an aperture 103 formed on the lens array 20 substrate, for example. In one embodiment, the output of the controller circuit 15, which is used to supply power to the LED array 10, can be adapted to also apply a voltage to the electrode pads 104, 106 via the electrically conductive wires 108, 110, respectively. In other embodiments, a separate defroster controller circuit may be employed to apply the voltage to the electrode pads 104, 106.

In one embodiment, the controller circuit 15 applies a voltage and/or current to the electrode pads 104, 106 in an open loop manner without any feedback. In various other embodiments, the controller circuit 15 applies a voltage and/or current to the electrode pads 104, 106 in response to a signal from a feedback element 153. The feedback element 153 is electrically coupled to electrically conductive electrode pads 113, 117, which are electrically coupled to the controller circuit 15 through the electrically conductive wires 107, 109. In various embodiments, the feedback element 153 may be any type of sensor capable of detecting condensation, fog, ice, rime, frost, and/or snow that may develop on the clear cover 30 and/or temperature of the clear cover 30.

In one embodiment, the feedback element 153 may comprise a solid state optical transducer probe available for aviation purposes. It has no moving parts, is completely solid and its principle of operation is entirely optical. The solid state optical sensor may be located on the interior portion 111 of the cover 30 and uses un-collimated light to monitor the opacity and optical refractive index of the substance on the probe. It may be de-sensitized to ignore a film of water. The device works as a combined optical spectrometer and optical switch. A change in opacity registers as rime ice. A change in refractive index registers as clear ice. Optical components are made of acrylic glass, which is the material used for aircraft covers 30. The wavelength of the optical transducer's excitation light is not visible to the human eye so as not to be mistaken for any kind of navigational running light.

In another embodiment, the feedback element 153 may be a solid state temperature sensor, including, for example, thermocouples, resistance temperature detectors (RTDs), thermistors. In one embodiment, the temperature sensors may be fabricated using state-of-the art thin film processing techniques. Those skilled in the art will appreciate that a thermocouple is a device consisting of two different conductors (usually metal alloys) that produce a voltage, proportional to a temperature difference, between either end of the two conductors. An RTD is a sensor used to measure temperature by correlating the resistance of the RTD element with temperature. Most RTD elements comprise a length of fine coiled wire wrapped around a ceramic or glass core. The element is usually quite fragile, so it is often placed inside a sheathed probe to protect it. Accordingly, it can be embedded in the cover 30 at the time of fabrication. The RTD element is made from a pure material whose resistance at various temperatures has been documented. The material has a predictable change in resistance as the temperature changes; it is this predictable change that is used to determine temperature. As they are almost invariably made of platinum, they are often called platinum resistance thermometers (PRTs). A thermistor is a type of resistor whose resistance varies significantly with temperature, more so than in standard resistors. The word is a portmanteau of thermal and resistor. Thermistors are widely used as inrush current limiters, temperature sensors, self-resetting overcurrent protectors, and self-regulating heating elements. Thermistors differ from resistance temperature detectors (RTD) in that the material used in a thermistor is generally a ceramic or polymer, while RTDs use pure metals. It will be appreciated, the in one embodiment, the feedback element 153 may comprise a combination of the solid state ice sensor and the temperature sensor operating simultaneously or intermittently, without limitation.

In one embodiment, the controller circuit 15 is electrically coupled to the feedback element 153 through the electrically conductive wires 107, 109, which may be fed through the aperture 103 formed on the lens array 20 substrate, for example. Depending on the type of feedback element 153, additional electrically conductive wires may be provided to couple the feedback element 153 to the controller circuit 15. Accordingly, in operation, the controller circuit 15 monitors the feedback element 153 and when it detects a signal indicative of condensation, fog, ice, rime, frost, snow, ice, and/or ice on the clear cover 30 and/or the temperature at the clear cover 30, the controller circuit 15 applies a voltage and/or current to the electrode pads 104, 106.

In one embodiment, heat may be conducted to the cover 30 from the lens array 20. This may be accomplished by physically contacting the surface of the lens array 20 to the bottom of the cover 30 such that heat generated by the LEDs from the LED array 10. This implementation requires a suitable thermal conductivity of the cover 30.

In various embodiments, a film suitable for use as the coating 101 on the glass cover 30 substrate may be formed of various compositions and thicknesses applied onto a glass substrate to produce a glass having a suitable sheet resistance in Ohms-per-square to generate enough thermal energy when an electrical current is conducted through the film to heat the glass and prevent the development of ice on the glass substrate without substantially affecting the light transmittance properties of the glass. The film composition may comprise tin-oxide or niobium doped tin oxide.

Such coatings 101 may be produced on glass substrates through a sputter coating (soft coat) or preferably, through a pyrolytic process, for example chemical vapor deposition. Typically, glass produced through a pyrolytic process yields a coating 101 which is less easily damaged and less likely to deteriorate under exposure to air.

Coatings 101 with sheet resistance value less than about 500 Ohms-per-square are generally considered to be electrically conductive coatings. The emissivity of a coated glass article is directly related to its sheet resistance. By lowering the sheet resistance, or increasing the conductivity, of a glass sheet, the emissivity is reduced. Total power to cover 30 suitable to evaporate condensation or fog and thaw frost, snow, or ice on the cover 30 of the lamp assembly 5A, for example, is about 1 Watt (W) to about 40 W, for a six-inch diameter aperture (e.g., the diameter of the cover 30), and more preferably a power density of about 1.5 W/in² to about 2.5 W/in².

A coating 101 of pure Tin-Oxide (SnO) formed on a glass substrate would have an extremely high sheet resistance. In practice, however, Tin-Oxide coatings typically have a sheet resistance of about 350-400 Ohms-per-square. This is due, at least in part, to an oxygen deficiency in the tin oxide, rendering it at least slightly electrically conductive. Fluorine may be used as a tin oxide dopant in order to increase the electrical conductivity. A fluorine doped tin oxide coating (SnO₂:F) can produce sheet resistances as low as about 16 Ω/cm². When tin oxide is doped with fluorine, the fluorine will substitute for oxygen in the compound. This substitution of fluorine for oxygen is a factor in the lowered sheet resistance, due to their differing electron configurations. Other materials have been also used as dopants in various glass coating applications.

Additional material may be used as dopants, alone or in combination with fluorine or other dopants, which results in a coating having a comparable or lowered emissivity for a given thickness, while maintaining or improving the ease and cost of manufacture of the coated glass products, and without impairing the optical qualities of the glass.

For example, in one embodiment, a niobium doped tin oxide is suitable for use with conventional tin oxide deposition precursors. The pyrolytic deposition enables the application of the film onto a float glass ribbon directly in the glass production process, preferably by CVD.

Glass substrates suitable for use in preparing the coated glass article may include any of the conventional clear glass compositions known in the art. The preferred substrate is a clear float glass ribbon wherein the coating 101, possibly with other optional coatings, is applied in the heated zone of the float glass process. Other conventional processes for applying the coating 101 on the glass substrate of the cover 30 are suitable for use in the embodiments according to the present disclosure.

For a pyrolytic deposition, the doped tin oxide alloy is deposited onto the glass substrate by incorporating a niobium source with conventional tin oxide precursors. An example would include the use of niobium pentachloride (NbCl₅) in an inert gas, such as helium. The NbCl₅ is a solid at normal atmospheric temperatures and pressures. Thus, for use as a dopant in the CVD process, the niobium pentachloride is vaporized and injected into a gas stream. A bubbler could be used, but in production conditions it would be preferable to use equipment such as a thin film evaporator to get the niobium pentachloride into the gas stream. Other possible niobium containing compounds are possible within the scope of the present invention. A significant factor in the selection of the niobium containing material is its volatility. Typically, the Nb containing material should be volatile at temperatures between 0 and 500° F., and in one embodiment, the Nb containing material should be volatile within the temperature range of 300-500° F. Niobium pentachloride is recommended both for its low melting point and because it is readily commercially available, however the present invention is intended to incorporate any known niobium compound suitable for doping tin oxide.

If the Tin-Oxide were to be doped with, for example, fluorine and niobium, a fluorine source would also then be used with the conventional tin oxide precursors. One fluorine source would be either HF or trifluoroacetic acid (TFA), but other conventional fluorine sources could be incorporated.

Tin precursors for glass coating processes are conventional and well known in the art. An especially suitable Tin containing compound is dimethyltin dichloride (DMT). This substance is well known and readily available, and is commonly used as a tin precursor material in known float glass coating applications. Other known tin precursors are also usable within the scope of the present disclosure.

In at least one possible process, NbCl₅ and DMT are run through thin film evaporators and are then mixed with oxygen and water in a helium carrier gas. The oxygen can be provided in the form of elemental oxygen or in the form of air, depending on the process employed. Other oxygen containing materials are certainly usable within the scope of the process, but it is generally most economical to use either air or elemental oxygen. The optional fluorine containing material (preferably HF) would also be added if fluorine doping was desired. The precursor materials can then be introduced into a coater, which directs the materials to the surface of a float glass ribbon. Care must be taken in the introduction of the materials however, as premature reaction of the NbCl₅ and water are possible. A niobium doped tin oxide film is then deposited on a float glass ribbon by conventional chemical vapor deposition techniques.

In the event that fluorine and niobium are being added in a dual doping system, the fluorine precursor and the H₂O can be run through the same thin film evaporator, although this is not necessary.

As opposed to conventional fluorine doping of tin oxide, wherein the fluorine atoms replace oxygen, the niobium atoms replace tin atoms in the tin oxide layer. Niobium is especially suited to this as it has a similar outer shell electron configuration to tin (5 electrons in the outer shell), and has an atomic number comparable to that of tin. Therefore, it is theorized that the niobium easily takes the place of the tin atoms in the tin oxide.

It has been found that doping with niobium alone can yield similar sheet resistance properties to doping with fluorine. It has also been found, however, that doping with both fluorine and niobium can yield sheet resistances superior to doping with either niobium or fluorine alone.

These and other processes for forming tin oxide coatings on glass and coated glass are described in U.S. Pat. No. 6,524,647 to Varanasi et al, entitled “Method of Forming Niobium Doped Tin Oxide Coatings on Glass and Coated Glass Formed Thereby,” and assigned to Pilkington plc., the disclosure of which is incorporated herein by reference.

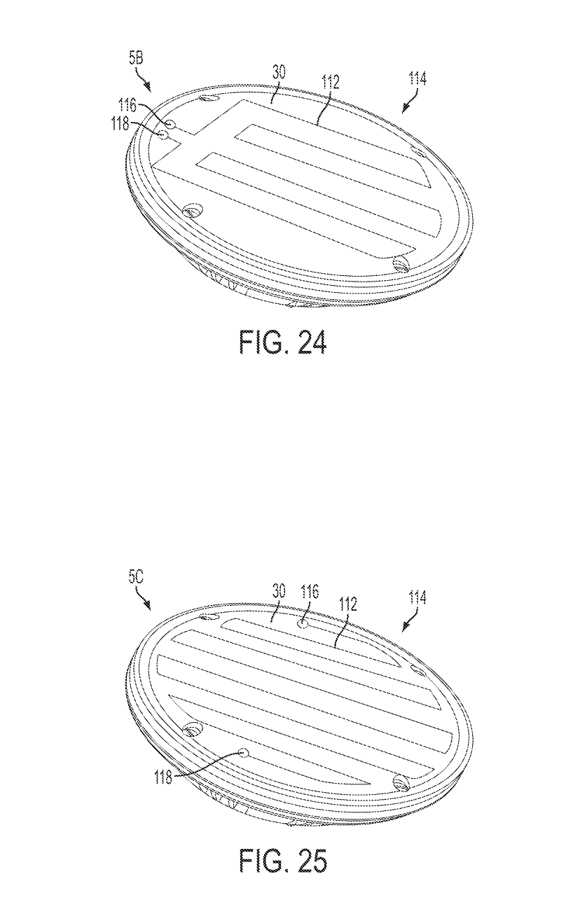

FIGS. 24 and 25 illustrate embodiments of the anti-icing lamp assembly 5. As shown in FIGS. 25 and 25 anti-icing lamp assemblies 5B, 5C, respectively, comprise electrically resistive heater conductors 112 according to various embodiments. FIG. 24 illustrates on embodiment of an anti-icing lamp assembly 5B comprising an electrically resistive heater conductor 112 for a transparent cover 30 according to one embodiment. The electrically resistive heater conductor 112 can have any form provided that it does not substantially affect the light transmittance properties of the cover 30. In one embodiment, the electrical resistive heater conductor 112 may be formed in a serpentine pattern 114, although other patterns may be suitable, as shown in accordance with one embodiment with respect to the anti-icing lamp assembly 5C shown in FIG. 25. The electrically resistive heater conductor 112 comprises terminals 116, 118, which are coupled to an energy source (e.g., voltage or current source) via electrically conductive wires in a similar manner to that disclosed in respect to FIGS. 24, 25, and 26. In one embodiment, the electrically resistive heater conductor 112 comprises a series of parallel linear resistive conductors in or on the glass.

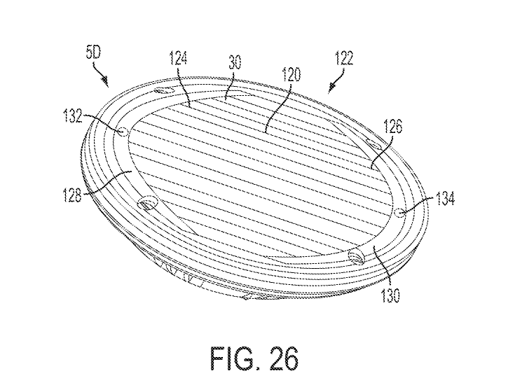

FIG. 26 illustrates one embodiment of the anti-icing lamp assembly 5. As shown in FIG. 26 anti-icing lamp assembly 5D comprises electrically resistive heater conductors 120 according to various embodiments. FIG. 26 illustrates an anti-icing lamp assembly 5D comprising an electrically resistive heater grid 122 according to one embodiment. In one embodiment, the electrically resistive heater grid 122 comprises a plurality of electrically resistive heater conductors each having first and second ends 124, 126, where the first and second ends 124, 126 are connected to respective first and second bus bars 128, 130. In another embodiment, the electrically resistive heater grid 122 may comprise a first group of resistive grid lines and a second group of resistive grid lines, with opposing ends of each group being connected to the first and second bus bars 128, 130. The resistive grid lines of the second group may be spaced between adjacent resistive grid lines of the first group, and the width of the resistive grid lines in the second group may be equal or less than the width of the grid lines in the first group. The bus bars 128, 130 are coupled to terminals 132, 134, which are coupled to a voltage source via electrically conductive wires in a similar manner to those disclosed in respect to FIGS. 24, 25, and 26.

Referring now to FIGS. 24-26, in one embodiment, the electrically resistive heater conductors 112, 120 are very fine wires embedded within or on the cover 30 or may be printed on the interior or exterior surface of cover 30 using electrically conductive inks. The electrically resistive heater conductors 112, 120 can have a variety of forms provided that they do not substantially affect the light transmittance properties of the cover 30. In various embodiments the electrically resistive heater conductors 112, 120 may be formed of any suitable materials such as Iron-Chrome Aluminum, Nickel-Chrome, Nickel-Iron, Nickel, Stainless Steel, Copper, Molybdenum, Tungsten, Molybdenum Disilicide MoSi2/MOSI, Silver-Ceramic, Silver ink or paste, for example. The electrically resistive conductor 112 in the form of fine wire may be embedded in the substrate using any suitable technique. Otherwise, the electrically resistive heater conductors 112, 120 may be deposited, screen printed, baked, or applied as a decal on the substrate. These conductors may be composed of a silver-ceramic material printed and baked onto the interior surface of the glass, or may be a series of very fine wires embedded within the glass. Although the surface-printed variety may be prone to damage by abrasion, it can be repaired easily with a conductive paint material.

When electrical power is applied to the terminals 116, 118 and 132, 134, the respective heater conductors 112, 120 heat up to substantially eliminate condensation, fog, frost, snow, or ice on the cover 30 of the anti-icing lamp assemblies 5B, 5C, 5D. The anti-icing lamp assemblies 5B, 5C, 5D described in FIGS. 24-26 should achieve a power density suitable to evaporate condensation or fog and thaw frost, rime, snow, or ice that forms on the cover 30 of the anti-icing lamp assemblies 5B, 5C, 5D, for example. A suitable power density is about 1 Watt (W) to about 2 W, and more preferably about 1.5 W/in² to about 1.8 W/in². In one embodiment, the energy source may be coupled to and controlled by the controller circuit 15, which may receive an activation input or a feedback signal to activate the energy source in order to conduct current through the heater conductors 112, 120.

Still referencing FIG. 26, in one example, the electrically resistive conductive heater grid 122 formed of electrical conductors, such as conductors 112, 120, may comprise multiple parallel gridlines. All spaced grid lines start and end at either a first or second bus bar 128, 130. These grids may be employed in glass panel substrates or polycarbonate panel substrates used to form the cover 30. Silver paste printed onto a glass panel substrate can be a conventional silver frit material used in the automotive industry. This conductive material can be screen printed onto the glass panel substrate and subsequently sintered at 1100° C. for 3.5 minutes, thereby leaving a silver frit material on the surface of the glass. A silver ink containing an organic binder (#11809 2k Silver, Creative Materials, Tyngsboro Mass.) can be screen printed onto a polycarbonate panel (polycarbonate, known under the trade name Makrolon Al2647, Bayer AG, Leverkusen, Germany) and subsequently cured at 100° C. for 30 minutes. The thickness of the resulting grid lines and bus bars 128, 130 on each of the defrosters can be found through the use of profilometry and may be on the order of 10-14 micrometers. The electrically resistive conductive heater grid 122 on the polycarbonate panel was finally subjected to the application of a silicone hard-coat system (SHP401/AS4000, GE Silicones, Waterford, N.Y.) to provide protection against weathering and abrasion. The application of 6.24 volts and 14.45 volts can establish a thermal equilibrium that is slightly less than the maximum limit of 70° C. in electrically resistive conductive heater grids 122 deposited on glass and on polycarbonate, respectively, under ambient (23° C.) air temperature. The electrically resistive conductive heater grid 122 on glass may defrost 75%-95% of the viewing area in a matter of minutes, for example. A further description of such electrically resistive conductive heater grids, including various test results, can be found in U.S. Pat. No. 7,297,902 to Weiss and entitled “High Performance Defrosters for Transparent Panels,” the disclosure of which is incorporated herein by reference.

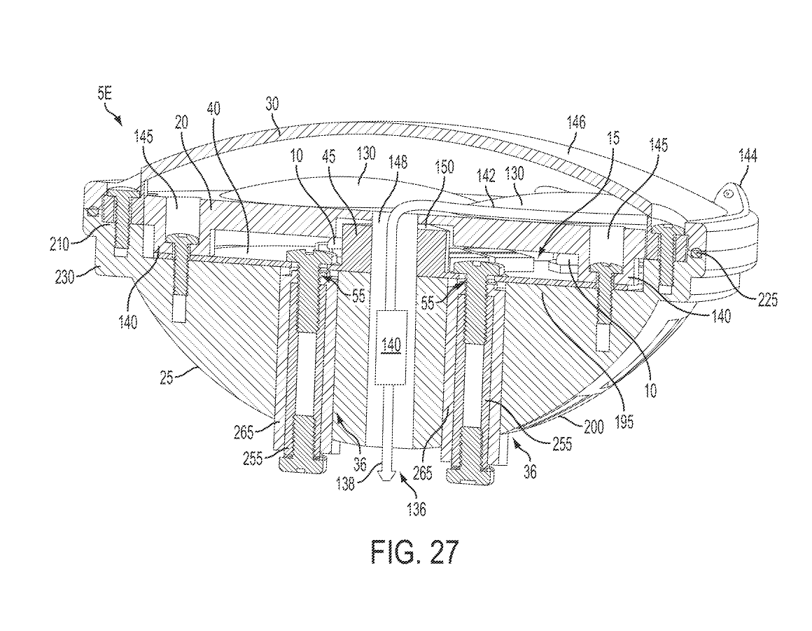

FIG. 27 illustrates one embodiment of the anti-icing lamp assembly 5. As shown in FIG. 27, an anti-icing lamp assembly 5E comprises an exothermic deicing thermal energy system 136 according to one embodiment. In this embodiment, the anti-icing lamp assembly 5E comprises a fluid connector 138 to fluidically couple to a reservoir filled with deicing fluid such as, for example, F-1 glycol or alcohol. The fluid connector 138 is fluidically coupled to a pump 140 located within an aperture 148 formed in the anti-icing lamp assembly 5E. The pump 140 is fluidically coupled to one or more fluid lines 142, which is fluidically coupled to a spray nozzle 144 located on an exterior surface of the anti-icing lamp assembly 5E. The spray nozzle 144 sprays the deicing fluid on an exterior surface 146 of the cover 30. In one embodiment, the pump 140 is electrically coupled to the controller circuit 15, which may receive an activation input or a feedback signal to activate the pump 140.

Any suitable deicing fluid used in commercial and general aviation may be employed in the exothermic deicing thermal energy system 136. In various embodiments, the deicing fluids come in a variety of types, and are typically composed of ethylene glycol (EG) or propylene glycol (PG), and may include other ingredients such as thickening agents, surfactants (wetting agents), corrosion inhibitors, and colored, UV-sensitive dye. Propylene glycol-based fluid is more common due to the fact that it is less toxic than ethylene glycol. The main component of deicing fluid is usually propylene glycol or ethylene glycol. Other ingredients vary depending on the manufacturer, but the exact composition of a particular brand of fluid is generally held as confidential proprietary information. Based on chemical analysis, the U.S. Environmental Protection Agency has identified five main classes of additives widely used among manufacturers:

Benzotriazole and methyl-substituted benzotriazole, used as corrosion inhibitor/flame retardants to reduce flammability resulting from the corrosion of metal components carrying a direct current.

Alkylphenol and alkylphenol ethoxylates, nonionic surfactants used to reduce surface tension.

Triethanolamine, used as a pH buffer.

High molecular weight, nonlinear polymers, used to increase viscoelasticity.

Colored dyes, such as azo, xanthene, triphenyl methane, and anthroquinone, used to aid in identification.

The use of 1,3-propanediol (a fermentation product of corn) as a base for deicing fluid is described in U.S. Patent Application Publication No. 2009/0283713 to Sapienza et al and entitled “Environmentally Benign Anti-Icing Or Deicing Fluids Employing Industrial Streams Comprising Hydroxycarboxylic Acid Salts And/Or Other Effective Deicing/Anti-Icing Agents,” which is incorporated herein by reference. Deicing fluids, including 1,3-propanediol, are available from Kilfrost, Inc. of Coral Springs, Fla. in the USA.

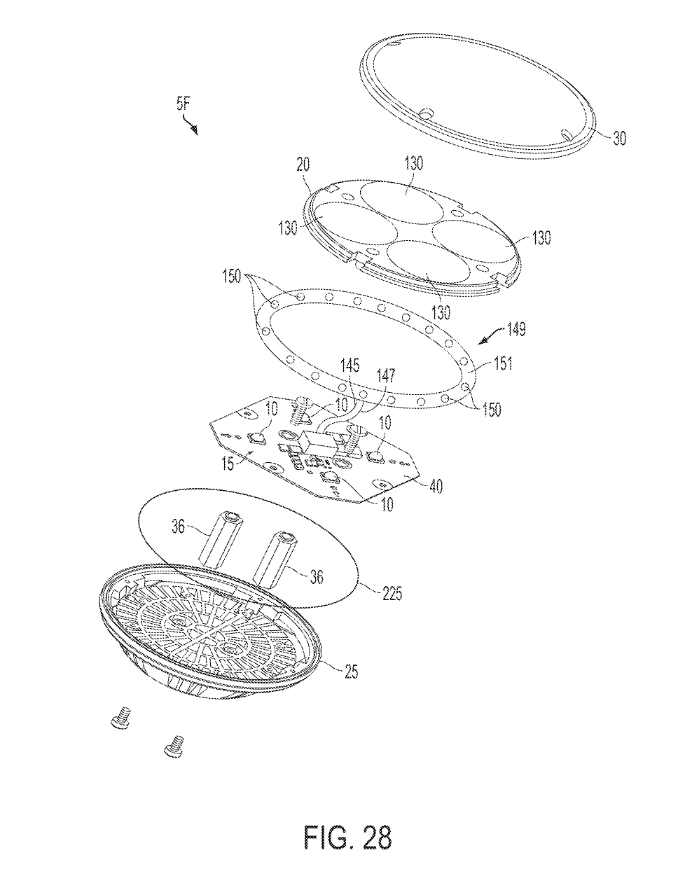

FIG. 28 illustrates one embodiment of the anti-icing lamp assembly 5. As shown in FIG. 28, an anti-icing lamp assembly 5F comprising an infrared (IR) thermal energy source 149 according to one embodiment. The anti-icing lamp assembly 5E comprises at least one infrared LED 150 located on a printed circuit board substrate 151. In one embodiment, a plurality of infrared LEDs 150 may be arranged in a circular array that produces heat when energized. In one embodiment, the infrared thermal energy source 149 is coupled to the controller circuit 15 by electrically conductive wires 145, 147. The controller circuit 15 is configured to receive an activation input or a feedback signal to activate the infrared thermal energy source 149.

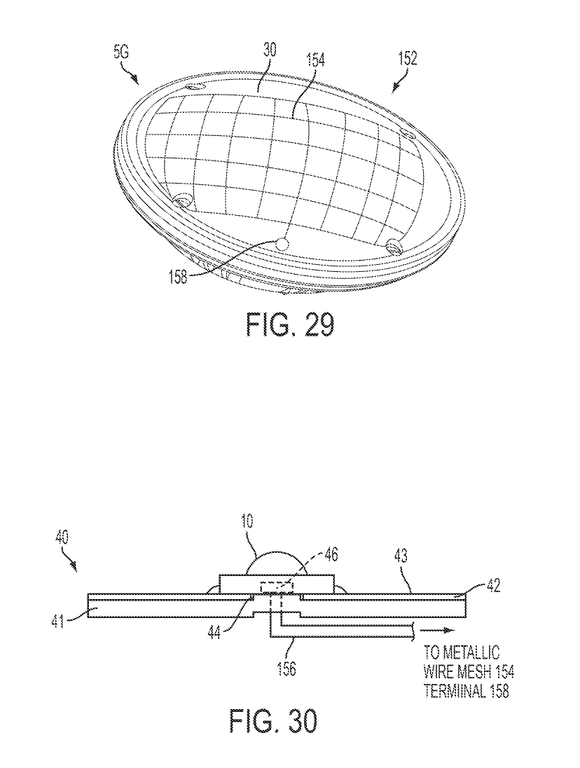

FIGS. 29 and 30 illustrate one embodiment of an anti-icing lamp assembly 5. As shown in FIGS. 29 and 30, an anti-icing lamp assembly 5G comprises a heat sink thermal energy transfer system 152 according to one embodiment. In one embodiment, a metallic wire mesh 154 having a higher thermal conductivity than the glass substrate of the cover 30 may be embedded or impregnated into the glass substrate to form a heat sink. The metallic wire mesh 154 is thermally coupled to the LED array 10 by thermal conductor 156 through a terminal 158, in place of the heat sink 46, to transfer heat from the LED array 10 or any other heat source of the electronic circuits of the anti-icing lamp assembly 5G. In one embodiment, the mesh 154 may be formed of grid of rectangles or squares, for example, where the individual wires are laid out at a predetermined pitch so as not to substantially affect the light transmittance properties of the glass, for example, such that the transmission of light is from about 80% to greater than about 90%. Accordingly, heat generated by the LED array 10 is transferred to the heat sink formed by the metallic wire mesh 154 to heat the cover 30 through thermal conduction. In this embodiment, no additional circuits are required and the glass of the cover 30 is kept warm by the heat generated by the LED array 10. In an alternative embodiment, the metallic wire mesh 154 may be thermally coupled to the existing heat sink 46 through the terminal 158 and thermal conductor 156 to transfer thermal energy from the heat sink 46 to the wire mesh 154 and heat the cover 30.

The wire mesh 154 and the thermal conductor 156 can be formed of any material having a thermal conductivity k greater than about 100 Watts per meter-Kelvin (W/m·K). Materials having a relatively high thermal conductivity include, without limitation, aluminum, gold, copper, and silver, among others. For example aluminum alloys have a thermal conductivity of about 120-180 W/m·K; pure aluminum have a thermal conductivity of about 237 W/m·K; gold has a thermal conductivity of about 518 W/m·K; copper has a thermal conductivity of about 401 W/m·K; silver has a thermal conductivity of about 429 W/m·K. In one embodiment, the wire mesh 154 and thermal conductor 156 may be formed of aluminum or any suitable thermal conductor such as, without limitation, gold, copper, or silver, among others.

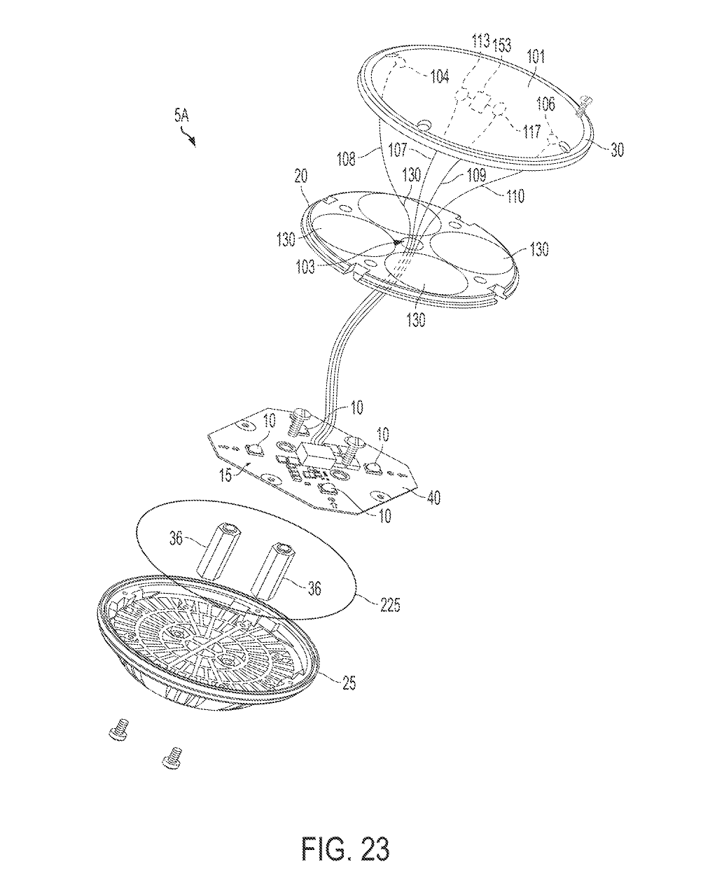

It will be appreciated, that each of the embodiments 5B, 5C, 5D, 5E, 5F, and 5G may comprise the feedback element 153 previously described in connection with FIG. 23. As previously discussed, the feedback element 153 provides a feedback signal to the controller circuit 15 that is indicative of condensation, fog, ice, rime, frost, snow, ice, and/or ice detected on the cover 30 and/or the temperature of the cover 30.

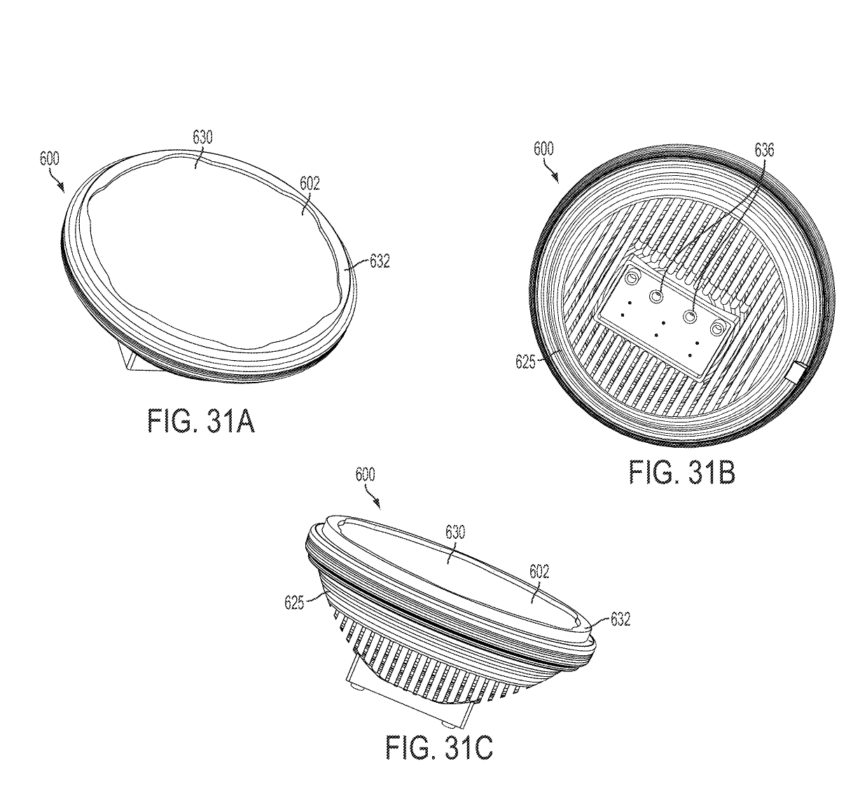

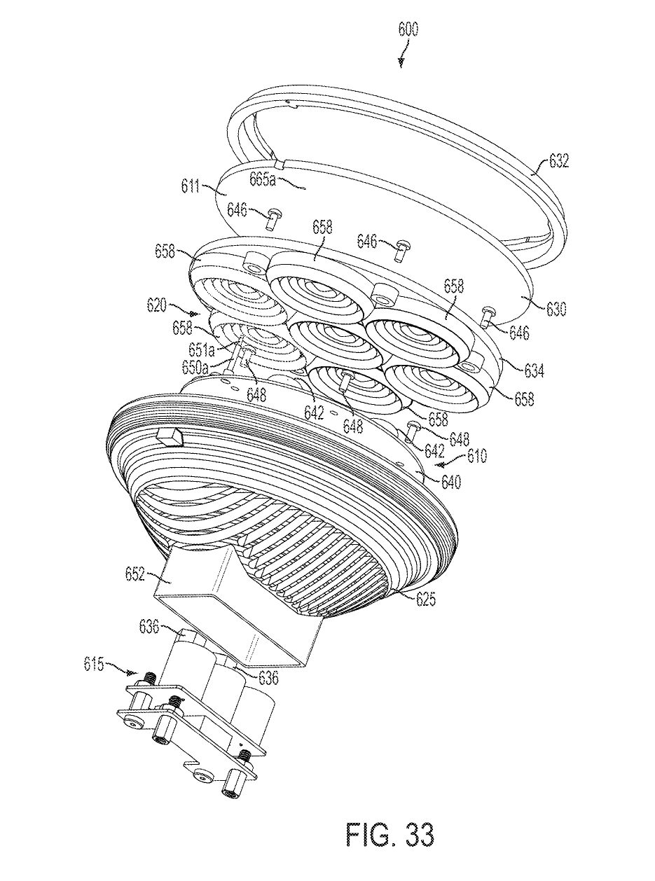

Another embodiment of an anti-icing lamp assembly 600 is shown in FIGS. 31A-31C are perspective views of a front, back and side, respectively, of an anti-icing lamp assembly 5 according to one embodiment. FIGS. 32 and 33 are exploded views of the anti-icing lamp assembly 600 illustrating components thereof. As discussed in further detail below, embodiments of the anti-icing lamp assembly 600 utilize LED technology to generate a light output. Light emitting diodes do not exhibit the large inrush current characteristics of incandescent filaments and are generally impervious to vibration. The anti-icing lamp assembly 600 thus provides significantly greater operating lifetimes in harsh mechanical environments, such as, for example, aircraft, motorcycle and off-road vehicle (e.g., Baja 500) environments or the like than may be realized using incandescent filament technology. Advantages of the anti-icing lamp assembly 600 are not limited to increased durability and longevity in harsh operating environments, and it will be appreciated that the anti-icing lamp assembly 600 may be used in other operating environments, such as, for example, automobile forward lighting environments, marine (e.g., underwater) environments and stage lighting operating environments, and not just for aircraft applications. Because embodiments of the anti-icing lamp assembly 600 may utilize an array of total internal reflection (TIR) lenses to extract light from LEDs, the light may be collected and redirected more efficiently compared to non-TIR light processing elements used for external aircraft lighting and other applications. Moreover, because embodiments of the anti-icing lamp assembly 600 may conform to certain mechanical, electrical and/or light output specifications of any of a number of existing incandescent filament lamps, aircraft, motorcycles, off-road vehicles and other equipment (vehicular or non-vehicular) may be retrofitted with the anti-icing lamp assembly 600 without the need for substantial modification, if any, of the associated equipment.

Still with reference to FIGS. 31-33, in one embodiment, an anti-icing lamp assembly 600 may comprise at least one solid state light source, for example. In one embodiment, the solid state light source comprises at least one LED. In some embodiments, the solid state light source comprises at least one LED array 610, a controller circuit 615 electrically coupled to the LED arrays 610, a lens array 620, a base 625, and a cover 630. The cover 630 may be configured and adapted to accommodate various embodiments of the defroster elements described hereinbelow. The cover 630 may be formed of any suitable glass or plastic substrate. A glass substrate may be formed of borosilicate, whereas a plastic substrate may be formed of polycarbonate resin, acrylic resin, polyarylate resin, polyester resin, polysulfone resin, polyvinyl butyral resin (PVB), and copolymers and mixtures thereof.

In one embodiment, the anti-icing lamp assembly 600 comprises a cover 630 that is substantially optically transparent. The cover 630 may comprise one or more defroster elements in accordance with the present disclosure to deice the cover 630, for example. As previously discussed, the term “deice” is used for conciseness and clarity and is intended to mean defog, demist, deice, prevent icing, clear or evaporate condensation or fog and thaw rime, frost, snow, or ice that may develop on the clear cover 630 of the anti-icing lamp assembly 600. The defroster elements may be configured to passively or directly provide thermal energy to an exterior surface 602 of the cover 630. In one embodiment, the defroster elements may be configured to generate thermal energy by conducting electrical current, alternating or direct current (AC or DC), pulsed, or modulated, through a resistive layer, coating, sheet, grid, or wire, or any combination thereof, formed integrally with or on an optically transparent substrate, e.g., the cover 630. In other embodiments, the defroster elements may be configured to generate thermal energy by exothermic chemical reactions that release energy in the form of heat. In other embodiments, the defroster elements may be configured to generate IR radiation energy. In other embodiments, the defroster elements may be configured as heat sinks to recover or recycle wasted heat from other sources in the lamp assembly or other aircraft systems. In other embodiments, heat sink elements embedded in the optically transparent substrate may be thermally coupled to other heat sink elements of the anti-icing lamp assembly 600 system. Before describing the various embodiments of defroster elements, the present disclosure continues with a description of one embodiment of the anti-icing lamp assembly 600. In one embodiment, the controller circuit 615 is the same or substantially similar to the controller circuit 15 previously discussed in connection with FIG. 10, for example.

In the assembled state of the anti-icing lamp assembly 600, as shown in FIGS. 31-33, the LED arrays 610, the controller circuit 615 and the lens array 620 may be received onto a front surface 695 of the base 625, with the cover 630 being disposed over the front surface 695 and attached to the base 625. The LED arrays 610, the controller circuit 615 and the lens array 620 may thus be protectably enclosed between the cover 630 and the base 625. The anti-icing lamp assembly 600 may additionally comprise a set of electrical connectors 636 disposed through the base 625 between the front surface 695 of the base 625 and a back surface 620 of the base 625. As discussed in further detail below, the electrical connectors 636 enable an electrical power system external to the anti-icing lamp assembly 600 (e.g., an aircraft electrical power system) to electrically connect to the LED arrays 610 and the controller circuit 615 and supply electrical power thereto. In one embodiment, the electrical connectors 636 are the same or substantially similar to the electrical connectors 36 described in connection with FIGS. 1-3 and 12.

Still with reference to FIGS. 31-33, in one embodiment, the base 625 portion of the anti-icing lamp assembly 600 comprises a housing portion 652 for receiving the controller circuit 615 therein. The base 625 also acts as a heat sink. A substrate 640 mounts to the base 625 via fasteners 648 (e.g., screw, bolt, rivet, snap). The fasteners 648 are received in corresponding threaded apertures 664 in the base 625. The LED arrays 610 comprising a mushroom-shaped deviator lens 642 are disposed to the substrate 640. As previously discussed, the mushroom-shaped deviator lens 642 is shaped to cause the TIR lens array 620 to provide uniform light output at an exit face 654 of the TIR lens frame 634. As shown, the substrate 640 comprises seven LED arrays 610 covered by seven corresponding mushroom-shaped deviator lenses 642. Each of the mushroom-shaped deviator lenses 642 transmits lights to seven corresponding TIR lenses 658 of the lens array 620. In various embodiments, the mushroom-shaped deviator lenses 642 and the TIR lens array 620 are the same or substantially similar to those described herein in connection with FIGS. 14-15 and 17-18. It will be appreciated that additional or fewer LED arrays 610, mushroom-shaped deviator lenses 642, and TIR lenses 658 may be provided on the substrate 640, without limitation. As shown, the LED arrays 610, the mushroom-shaped deviator lenses 642, and the corresponding TIR lenses 658 are arranged with six elements around the perimeter of the substrate (outside lenses) and one in the center (central lens). It will be appreciated that other configurations are contemplated and the embodiments should not be limited as such. Pogo pins 651a, 651b, 651c, 651d comprising corresponding pogo pin holders 650a, 650b, 650c, 650d are provided on the substrate 640. The pogo pins 651a-d may be used to provide electrical contact to corresponding electrode pads 665a, 665b, 665c, 665d of the cover 630 through corresponding apertures 663a, 663b, 663c, 663d in the TIR lens frame 634. Accordingly, the electrode pads 665a-d are electrically coupled to various circuit elements of the controller circuit 615. In one embodiment, the cover 630 may comprise a feedback element 667, which is similar to the feedback element 153 as previously described in connection with FIG. 23. As previously discussed, the feedback element 667 provides a signal to the controller circuit 615 that is indicative of condensation, fog, ice, rime, frost, snow, ice, and/or ice detected on the cover 630 and/or the temperature of the cover 630. The feedback element 667 is electrically coupled between electrode pads 665c, 665d. The pogo pins 651c, 661d electrically provide the feedback signal generated by the feedback element 667 to the controller circuit 615. In response the feedback signal, the controller circuit 615 applies a voltage and/or current to the electrode pads 665a, 665b. Either electrode pad 665a, 665b may act as the positive (+) electrode, provided that the other pad acts as the negative (−) terminal.

Electrical connectors 660 provide electrical contact from the controller circuit 615 to the substrate 640 to power LED arrays 610. A plurality of TIR lens frame fasteners 646 (e.g., screws, bolts, rivets, snaps) connect the TIR lens frame 634 to the base 625. In the illustrated embodiment, the fasteners 646 couple to standoffs 662 in the base 625. A retainer ring 632 couples the cover 630 to the base 625.

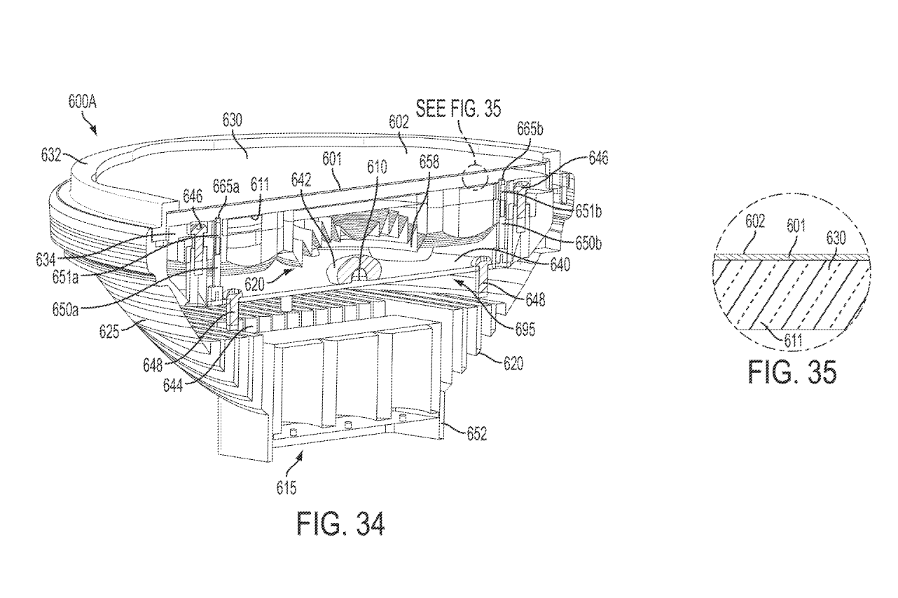

FIG. 34 is a perspective cross-sectional view of one embodiment of an anti-icing lamp assembly 600A and FIG. 35 is a detail view of a cross-section of the lens cover 630 of the anti-icing lamp assembly 600A. FIGS. 34-35 illustrate that in one embodiment the anti-icing lamp assembly 600A comprises an electrically conductive coating 601 according to one embodiment. In one embodiment, the electrically conductive coating 601 is substantially optically transparent and is formed on the exterior surface 602 of the optically transparent cover 630. One type of electrically conductive coating 601 that may be applied to the glass cover 630 is known under the trade name “TEC Glass” available from Pilkington Specialty Glass Products of Toledo, Ohio. The transparent electrically conductive coating 601 formed on the glass cover 630 substrate is a thin pyrolytic film that can be directly electrically heated to clear or evaporate condensation or fog and thaw or deice rime, frost, snow, or ice that may develop on the clear cover 630 portion of the anti-icing lamp assembly 600A, for example. In one embodiment, the transparent electrically conductive coating 601 is the same or substantially similar to the electrically conductive coating 101 described in connection with FIGS. 21 and 22. Details of the electrically conductive coatings 101, 601 have been previously described in connection with FIGS. 21 and 22 and for conciseness and clarity of disclosure will not be repeated here. In one embodiment, the electrically conductive coating 601 may be electrically driven by the controller circuit 615 by way of the pogo pins 651, for example, which electrically couple the controller circuit 615 to the coating 601.

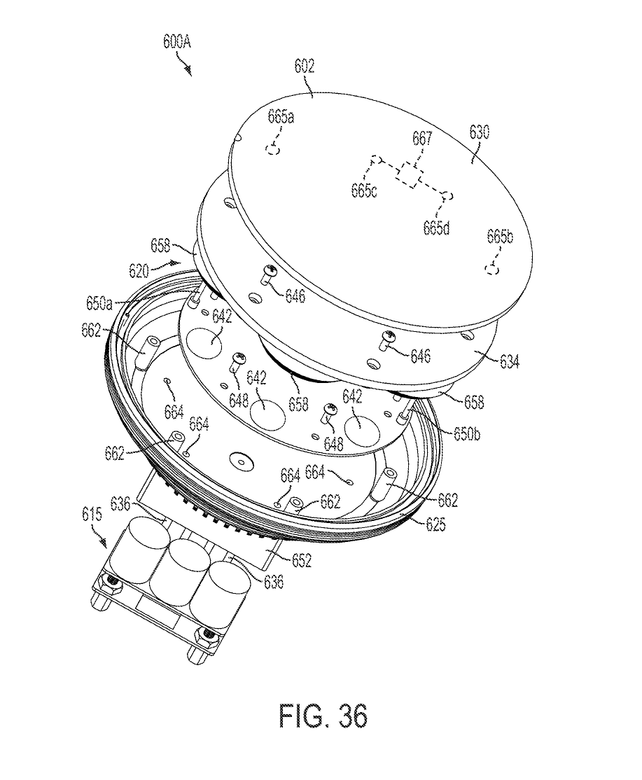

FIG. 36 illustrates an exploded view of one embodiment of the anti-icing lamp assembly 600A with the retainer ring 632 removed to more clearly show the outer surface 602 of the cover 630. As shown in FIG. 36, in one embodiment, the cover 630 may comprise a first pair of electrically conductive electrode pads 655a, 655b, which may be formed on opposite sides of the exterior surface 602 of the cover 630. A suitable electrical voltage and/or current can be applied to the electrode pads 655a, 655b via corresponding pogo pins 651a, 651b through apertures 663a, 663b formed in the TIR lens frame 634, for example, or suitable electrically conductive wires, such as electrically conductive wires 108, 110 shown in FIG. 23. When a voltage is applied to the terminals 604, 606, an electrical current is generated through the resistive pyrolytic coating 601, which heats the cover 630 to evaporate condensation or fog and thaw frost, snow, or ice on the cover 630 of the lamp assembly 600A, for example. In the embodiment illustrated in FIG. 36, the electrical current conducted across the sheet resistance of the coating 601 heats the exterior surface 602 of the cover 630, thus minimizing the amount of energy required to heat the cover 630. In other embodiments, for completeness of disclosure, the coating 601 may be applied to an interior portion 611 of the cover 630. In such embodiment, the heat would be transferred through the glass substrate of the cover 630, which has poor thermal conduction properties.

As also shown in FIG. 36, in one embodiment, the electrically conductive electrode pads 665a-d (e.g., or bus bars), which are the same or substantially similar to the electrode pads 104, 106 shown in FIG. 23. The electrode pads 665a-d may be screen printed onto opposing sides of an exterior or interior surface 602, 611 of the cover 630 prior to the application of the coating 601. The electrode pads 665a-d may be screen printed using electrically conductive inks or pastes, such as, for example, Palladium Silver, among other electrically conductive inks or pastes. In other embodiments, the electrode pads 665a-d may be formed of electrically conductive adhesive decals applied to the coating 601 and electrically coupled to the energy source via terminals provided on the cover 630 and corresponding conductors to couple to the controller circuit 615, for example. In various embodiments, electrically conductive adhesive decals may include conductive adhesives, inks, foil, tape, transfer tape, among others. The electrode pads 665a, 665b may be configured to receive an electrical voltage, which is converted to an electrical current through the sheet resistance of the coating 601. The electrodes 665a, 65b are electrically coupled to the controller circuit 615 via the pogo pins 651a, 651b. In one embodiment, a constant current may be supplied to the electrode pads 665a, 665b by a suitable electrical circuit. In one embodiment, the electrode pads 665c, 665d electrically couple to the feedback element 667 and to the controller circuit 615 via the pogo pins 651c, 651d. If the electrode pads 665a-d are formed on the interior surface 611 of the cover 630 an electrical connection may be provided to the coating 601 though the cover 630.

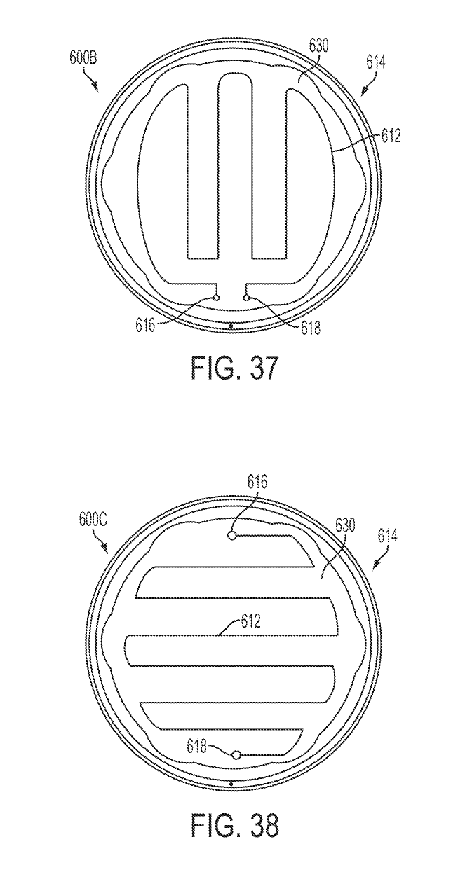

FIGS. 37 and 38 illustrate embodiments of the anti-icing lamp assembly 600. As shown in FIGS. 37 and 38 anti-icing lamp assemblies 600B, 600C, respectively, comprise electrically resistive heater conductors 612 according to various embodiments. FIG. 37 illustrates on embodiment of an anti-icing lamp assembly 600B comprising an electrically resistive heater conductor 612 for a transparent cover 630 according to one embodiment. The electrically resistive heater conductor 612 can have any form provided that it does not substantially affect the light transmittance properties of the cover 630. In one embodiment, the electrical resistive heater conductor 612 may be formed in a serpentine pattern 614, although other patterns may be suitable, as shown in accordance with one embodiment with respect to the anti-icing lamp assembly 600C shown in FIG. 38. The electrically resistive heater conductor 612 comprises terminals 616, 618, which are coupled to an energy source (e.g., voltage or current source) via electrically conductive wires in a similar manner previously disclosed herein. In one embodiment, the electrically resistive heater conductor 612 comprises a series of parallel linear resistive conductors in or on the glass. In one embodiment, the electrically resistive heater conductor 612 is the same or substantially similar to the electrically resistive heater conductor 112 described in connection with FIGS. 24 and 25.

FIG. 39 illustrates one embodiment of the anti-icing lamp assembly 600. As shown in FIG. 39 anti-icing lamp assembly 600D comprises electrically resistive heater conductors 621 according to various embodiments. FIG. 39 illustrates an anti-icing lamp assembly 600D comprising an electrically resistive heater grid 622 according to one embodiment. In one embodiment, the electrically resistive heater grid 622 comprises a plurality of electrically resistive heater conductors each having first and second ends 624, 626, where the first and second ends 624, 626 are connected to respective first and second bus bars 628, 630 (e.g., electrode pads). In another embodiment, the electrically resistive heater grid 622 may comprise a first group of resistive grid lines and a second group of resistive grid lines, with opposing ends of each group being connected to the first and second bus bars 628, 630. The resistive grid lines of the second group may be spaced between adjacent resistive grid lines of the first group, and the width of the resistive grid lines in the second group may be equal or less than the width of the grid lines in the first group. The bus bars 628, 630 are coupled to terminals 632, 634, which are coupled to a voltage source via electrically conductive wires in a similar manner to that previously disclosed herein.

Referring now to FIGS. 37-39, in one embodiment, the electrically resistive heater conductors 612, 621 are very fine wires embedded within or on the cover 630 or may be printed on the interior or exterior surface of cover 630 using electrically conductive inks. The electrically resistive heater conductors 612, 621 can have a variety of forms provided that they do not substantially affect the light transmittance properties of the cover 630. In one embodiment, the electrically resistive heater conductors 612, 621 are the same or substantially similar to the electrically conductive heaters 612, 621 discussed in connection with FIGS. 24-26. Accordingly, when electrical power is applied to the terminals 616, 618 and 632, 634, the respective heater conductors 612, 621 heat up to substantially clear or evaporate condensation or fog and thaw or deice rime, frost, snow, or ice that may develop on the clear cover portion 630 of the anti-icing lamp assemblies 600B, 600C, 600D. The anti-icing lamp assemblies 600B, 600C, 600D described in FIGS. 37-39 should achieve a power density suitable to substantially clear or evaporate condensation or fog and thaw or deice rime, frost, snow, or ice that may develop on the clear cover portion 630 of the anti-icing lamp assemblies 600B, 600C, 600D, for example. A suitable power density is about 1 W/in² to about 2.5 W/in², and more preferably about 1.5 W/in² to about 1.8 W/in². In one embodiment, the energy source may be coupled to and controlled by the controller circuit 15, which may receive an activation input or a feedback signal to activate the energy source in order to conduct current through the heater conductors 612, 621.

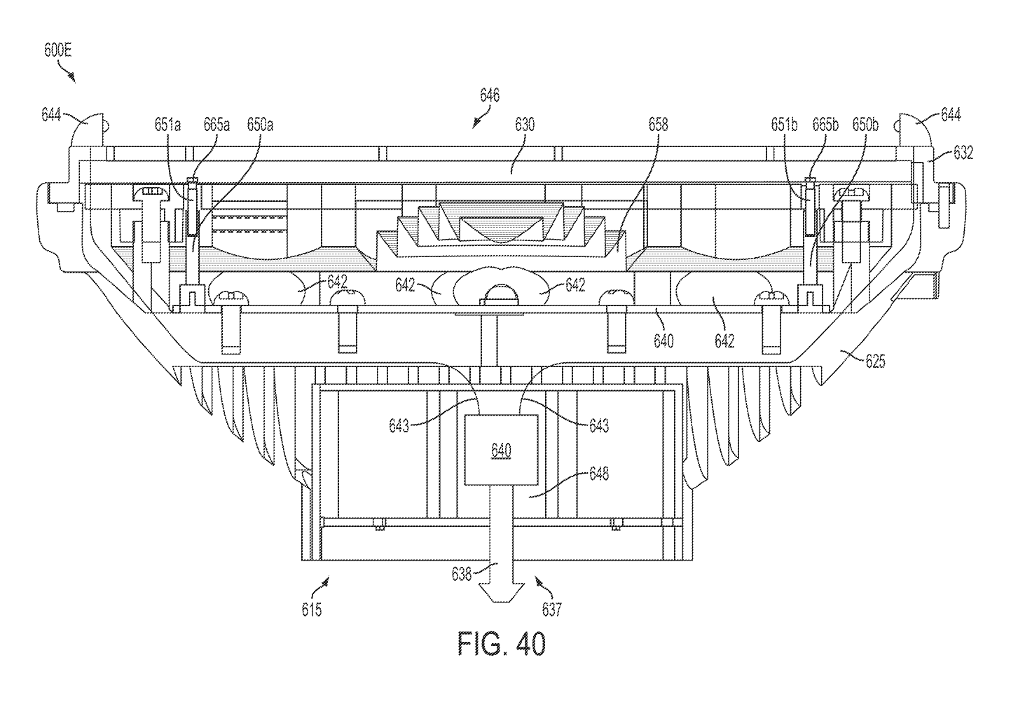

FIG. 40 illustrates one embodiment of the anti-icing lamp assembly 600. As shown in FIG. 40, an anti-icing lamp assembly 600E comprises an exothermic deicing thermal energy system 637 according to one embodiment. In this embodiment, the anti-icing lamp assembly 600E comprises a fluid connector 638 to fluidically couple to a reservoir filled with deicing fluid such as, for example, F-1 glycol or alcohol. The fluid connector 638 is fluidically coupled to a pump 640 located within an aperture 648 formed in the anti-icing lamp assembly 600E. The pump 640 is fluidically coupled to one or more fluid lines 642, which are fluidically coupled to one or more spray nozzles 644 located on an exterior surface of the anti-icing lamp assembly 600E. The spray nozzles 644 spray the deicing fluid on an exterior surface 646 of the cover 630. In one embodiment, the pump 640 is electrically coupled to the controller circuit 615, which may receive an activation input or a feedback signal to activate the pump 640. Any suitable deicing fluid used in commercial and general aviation may be employed in the exothermic deicing thermal energy system 637, for example, the deicing fluid previously discussed in connection with FIG. 27, without limitation.

FIG. 41 illustrates one embodiment of the anti-icing lamp assembly 600. As shown in FIG. 41, illustrates an anti-icing lamp assembly 600F comprises an infrared (IR) thermal energy source 649 according to one embodiment. The anti-icing lamp assembly 600F comprises at least one infrared LED 653 located on a printed circuit board substrate 655. In one embodiment, a plurality of infrared LEDs 653 may be arranged in a circular array that produces heat when energized. In one embodiment, the infrared thermal energy 649 is coupled to the controller circuit 615 by electrically conductive wires 645, 647. The controller circuit 615 is configured to receive an activation input or a feedback signal to activate the infrared thermal energy source 649.

FIG. 42 illustrates one embodiment of the anti-icing lamp assembly 600. As shown in FIG. 42, an anti-icing lamp assembly 600G comprises a heat sink thermal energy transfer system 657 according to one embodiment. In one embodiment, a metallic wire mesh 659 having a higher thermal conductivity than the glass substrate of the cover 630 may be embedded or impregnated into the glass substrate to form a heat sink. The metallic wire mesh 659 is thermally coupled to the heat sink base 625 by a thermal conductor through a terminal 661 to transfer heat generated by the LED array 610, or any other heat source of the electronic circuits, of the anti-icing lamp assembly 600G. In one embodiment, the mesh 659 may be formed of grid of rectangles or squares, for example, where the individual wires are laid out at a predetermined pitch so as not to substantially affect the light transmittance properties of the glass, for example, such that the transmission of light is from about 80% to greater than about 90%. Accordingly, heat generated by the LED array 610 is transferred to the heat sink formed by the metallic wire mesh 659 to heat the cover 630 through thermal conduction. In this embodiment, no additional circuits are required and the glass of the cover 630 is kept warm by the heat generated by the LED array 610. In an alternative embodiment, the metallic wire mesh 659 may be thermally coupled to the existing heat sink 625 through the terminal 661 and thermal conductors to transfer thermal energy from the heat sink 625 to the wire mesh 659 and heat the cover 630.

The wire mesh 659 and the thermal conductor can be formed of any material having a thermal conductivity k greater than about 100 Watts per meter-Kelvin (W/m·K). Materials having a relatively high thermal conductivity include, without limitation, aluminum, gold, copper, and silver, among others. For example aluminum alloys have a thermal conductivity of about 120-180 W/m·K; pure aluminum have a thermal conductivity of about 237 W/m·K; gold has a thermal conductivity of about 318 W/m·K; copper has a thermal conductivity of about 401 W/m·K; silver has a thermal conductivity of about 429 W/m·K. In one embodiment, the wire mesh 659 and thermal conductor may be formed of aluminum or any suitable thermal conductor such as, without limitation, gold, copper, or silver, among others.

It will be appreciated, that each of the embodiments 600B, 600C, 600D, 600E, 600F, and 600G may comprise the feedback element 667 previously described in connection with FIGS. 32-36. As previously discussed, the feedback element 667 provides a feedback signal to the controller circuit 615 that is indicative of condensation, fog, ice, rime, frost, snow, ice, and/or ice detected on the cover 630 and/or the temperature of the cover 630.

Having described various embodiments of defroster elements that can be employed in various embodiments of anti-icing lamp assemblies 5, 5A-G, 600, 600A-600G, the description now turns to a brief discussion of the power dissipated by conventional aircraft lamp assembly as compared with the total power dissipated by an anti-icing solid state aircraft lamp assembly according to the disclosed embodiments. Conventional aircraft lamp assemblies comprising incandescent lamps dissipate anywhere from 250 W to 450 W and up to 600 W for the big landing lights on a Boeing aircraft, for example. A typical solid-state LED aircraft lamp assembly as dissipates a maximum of about 70 W, which is a significant power savings for the airlines even for the 250 W to 450 W aircraft lamp assemblies. In addition, because incandescent lamps burn out and they are relatively inexpensive, for example, an aircraft landing light for a Boeing 747 costs about $130. However, to change an incandescent lamp requires a mechanic to open up the wing of the aircraft and change the lamp. Accordingly, the cost for changing two lamps on a Boeing 747 aircraft may be on the order of $2500 including the labor. So you're talking about an additional 40 watts. An anti-icing solid state LED lamp assembly comprising heater elements as discussed herein will typically require an additional 30 W to 40 W (for a total of about 100 W to 110 W versus a corresponding 250 W to 450 W) that needs to be expended on the glass surface of the cover 30, 630 in order to generate a suitable amount of heat through the resistive or infra-red elements as discussed with reference to the anti-icing lamp assemblies 5, 5A-5G, 600; 600A-600G. For the larger aircraft lamp assemblies in the 600 W, a corresponding anti-icing solid state aircraft lamp assembly consumes about 200 W. Embodiments of the anti-icing lamp assemblies 5, 5A-5G, 600, 600A-600G, discussed above, each comprise a controller circuit 15 that may be configured with logic (e.g., software, firmware, hardware, or combination thereof) to monitor for temperatures above a predetermined threshold (e.g., 40° F.) when the defroster elements are turned off to conserve energy. I believe, umm, for the larger, the 600 watt lamp, we were umm, let's see, we were around 200 watts.

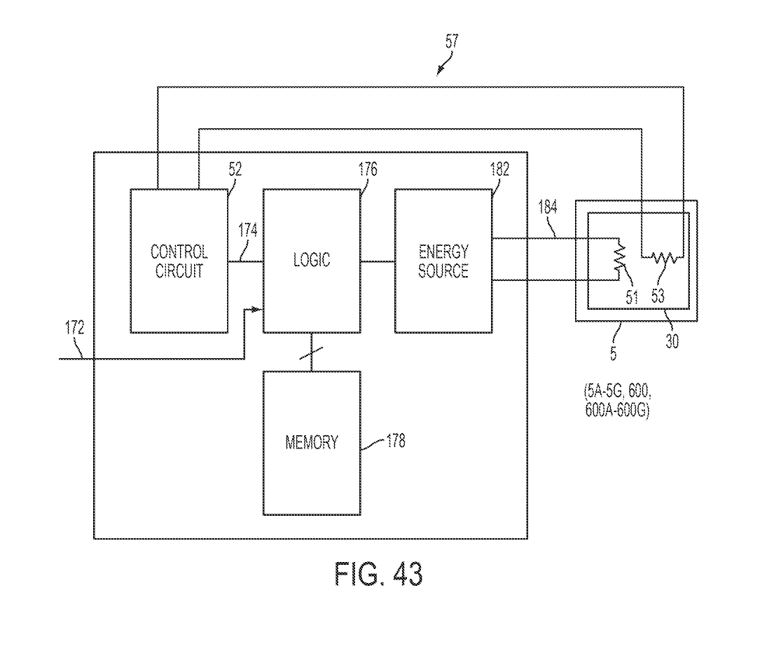

FIG. 43 illustrates a block diagram of one embodiment of a controller circuit 170 for controlling the operation of the anti-icing lamp assemblies discussed herein according to various embodiments. In one embodiment, the controller circuit 170 comprises a logic circuit 176 coupled to an energy source 182. In one embodiment, the energy circuit 182 may be the DC-DC controller 90 described in connection with FIG. 10, for example. In one embodiment, the logic circuit 176 may be a programmable device such as a state machine or a processor. One embodiment of a programmable logic circuit 176 includes a processor coupled to a memory 178. Another embodiment of a programmable logic circuit 176 includes a Programmable Logic Device (PLD) or a Field Programmable Gate Array (FPGA). The logic circuit 176 may receive inputs from multiple sources. In one embodiment, the logic circuit 176 may receive an activation input signal 172, which may be generated by aircraft personnel such as the pilot or other members of the crew, aircraft mechanics, and the like. In one aspect, the activation input signal 172 may be a simple virtual, mechanical, or electromechanical switch, that the aircraft personnel actuates when the aircraft is landing or taxing under conditions conducive to condensation, fog, frost, snow, or ice forming on the exterior surface of the cover 30. When the logic circuit 176 receives the activation input signal 172, the logic circuit 176 activates the energy source 182 to drive the defrosting element 51 of the anti-icing aircraft lamp 5, 5A-5G, 600, 600A-600G such as, for example, the electrically conductive coating 101, 601 the electrically resistive heater conductors 112, 120, 612, 621 the pump 140, 640 to activate the exothermic defrosting system 136, 637 and/or the IR energy source 149, 649 to generate IR heat, among other defrosting elements.

In one embodiment, a control circuit 52 is configured to receive a feedback signal 57 from a feedback element 53, which includes any suitable electronic sensors or electronic components such as the feedback element 153, 667 described in connection with FIGS. 23 and 32-36, or other feedback sensors associated with the aircraft. For example, the feedback signal 57 also may be received from temperature sensors configured to measure outdoor ambient temperature, wind speed, humidity, barometric pressure, aircraft speed, and the like. The logic circuit 176 is configured to activate the energy source 182 based on the activation input signal 172 or the output signal 174 of the control circuit 52, or both the activation input signal 172 and the output signal 174. When activated, the energy source 182 drives the defroster element 51. In embodiments where the logic circuit 276 is a processor, logical instructions may be stored in the memory 178 that when executed, cause the processor to determine whether to activate the energy source 182 based on the activation input signal 172 or the output signal 174 of the control circuit 52, or both the activation input signal 172 and the output signal 174 drive the defroster element 51 in response thereto. Accordingly, the logic circuit 176 may be programmed to automatically activate the energy source 182. In one embodiment, the control circuit 52 may be integrated with the controller circuit 15, 615. In various embodiments, the energy source 182 may be configured to supply voltage or current, either AC or DC, or may supply voltage or current pulses to an output terminal 184 coupled to the defroster element 51 discussed herein. In various embodiments, an analog-to-digital converter (ADC) may be employed to provide digital inputs to the logic circuit 176.

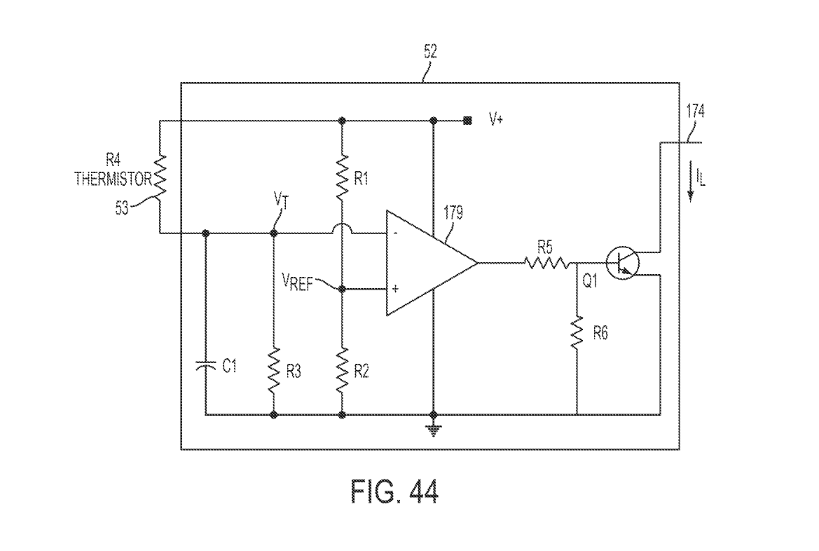

FIG. 44 illustrates one embodiment of a control circuit 52 suitable for use with a thermistor type feedback element. The control circuit 52 uses the thermistor R4 as the feedback element 53 to sense low temperatures, such as 32° F. (or 0° C.). Basically, the control circuit 52 uses a thermistor R4 to sense the temperature of the cover 30. The control circuit 52 produces an output signal 174 when the temperature falls below zero degrees, for example. An operational amplifier 179 (e.g., Opamp LM7215) is used to compare a reference voltage V_{REF} at the non inverting input (+) of the amplifier 179 with the voltage V_{T} from the thermistor R4 at the inverting input (−) of the amplifier 179. When temperature of the cover 30 become less than zero degrees, for example, the non inverting input (+) voltage V_{REF} exceeds the voltage V_{T} at the inverting input (−), and the amplifier 179 output become high. This makes transistor Q1 ON and drives a current I_{L} from the output of the transistor Q1 when resistor R7 is connected to a supply voltage. In one embodiment, the thermistor R4 may be a glass bead type thermistor No: Keystone RL0503-5536-122-MS (361K @ 0 degree Celsius and 100K @ 25 degree Celsius, without limitation. Any other suitable temperature sensor and corresponding circuit may be employed, without limitation.

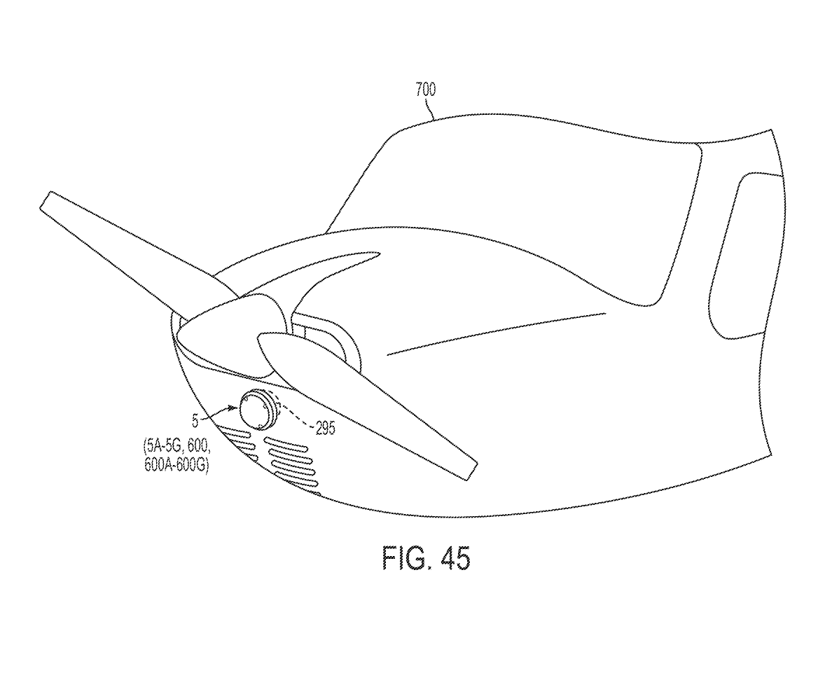

FIG. 45 illustrates an installed configuration of the anti-icing lamp assembly 5 (5A-5G, 600, 600A-600G), according to one embodiment. As shown, the anti-icing lamp assembly 5 (5A-5G, 600, 600A-600G) is retrofitted into a cowl-mounted PAR-36 incandescent lamp holder 295 of an aircraft 700 to operate as an aircraft landing light. It will be appreciated that the anti-icing lamp assembly 5 (5A-5G, 600, 600A-600G) may also be used in other harsh operating environments such as, for example, motorcycle and off-road vehicle (e.g., Baja 500) environments. Notwithstanding the advantages of increased durability and longevity afforded by the anti-icing lamp assembly 5 (5A-5G, 600, 600A-600G) in such environments, it will be appreciated that the anti-icing lamp assembly 5 (5A-5G, 600, 600A-600G) may be used in a number of other operating environments, such as, for example, automobile forward lighting environments, marine (e.g., underwater) environments and stage lighting operating environments.

While various details have been set forth in the foregoing description, it will be appreciated that the various aspects of the anti-icing solid state aircraft lamp assembly may be practiced without these specific details.

It is worthy to note that any reference to “one aspect,” “an aspect,” “one embodiment,” or “an embodiment” means that a particular feature, structure, or characteristic described in connection with the aspect is included in at least one aspect. Thus, appearances of the phrases “in one aspect,” “in an aspect,” “in one embodiment,” or “in an embodiment” in various places throughout the specification are not necessarily all referring to the same aspect. Furthermore, the particular features, structures or characteristics may be combined in any suitable manner in one or more aspects.

Some aspects may be described using the expression “coupled” and “connected” along with their derivatives. It should be understood that these terms are not intended as synonyms for each other. For example, some aspects may be described using the term “connected” to indicate that two or more elements are in direct physical or electrical contact with each other. In another example, some aspects may be described using the term “coupled” to indicate that two or more elements are in direct physical or electrical contact. The term “coupled,” however, also may mean that two or more elements are not in direct contact with each other, but yet still co-operate or interact with each other.

While certain features of the aspects have been illustrated as described herein, many modifications, substitutions, changes and equivalents will now occur to those skilled in the art. It is therefore to be understood that the appended claims are intended to cover all such modifications and changes as fall within the true scope of the disclosed embodiments.

1. An anti-icing solid state aircraft lamp, comprising:
at least one solid state light source;
a substantially optically transparent cover optically coupled to the at least one solid state light source; and
at least one defroster element coupled to the optically transparent cover.

2. The anti-icing solid state aircraft lamp of claim 1, wherein the at least one solid state light source comprises at least one light emitting diode (LED).

3. The anti-icing solid state aircraft lamp of claim 1, further comprising a controller circuit coupled to the at least one defroster element to drive the at least one defroster element in response to an input signal.

4. The anti-icing solid state aircraft lamp of claim 3, further comprising a feedback element located on the optically transparent cover to produce a feedback in response to a detected condition of the optically transparent cover, wherein the feedback element is electrically coupled to the controller circuit, and wherein the controller circuit is configured to drive the at least one defroster element in response to the feedback signal.

5. The anti-icing solid state aircraft lamp of claim 4, wherein the feedback element is a temperature sensor.

6. The anti-icing solid state aircraft lamp of claim 5, wherein the temperature is a thermistor.

7. The anti-icing solid state aircraft lamp of claim 4, wherein the feedback element is a solid state ice sensor.

8. The anti-icing solid state aircraft lamp of claim 3, wherein the at least one defroster element comprises a substantially transparent electrically conductive coating formed on the optically transparent cover and electrically coupled to the controller circuit.

9. The anti-icing solid state aircraft lamp of claim 3, wherein the cover comprises first and second electrically conductive electrode pads electrically coupled to the substantially transparent electrically conductive coating and the controller circuit.

10. The anti-icing solid state aircraft lamp of claim 9, wherein the substantially transparent electrically conductive coating is a thin pyrolytic film.

11. The anti-icing solid state aircraft lamp of claim 3, wherein the cover comprises third and fourth electrically conductive electrode pads electrically coupled to a feedback element and the controller circuit, wherein the feedback element is located on the optically transparent cover.

12. The anti-icing solid state aircraft lamp of claim 4, wherein the at least one defroster element comprises at least one electrical resistive heater conductor electrically coupled to the controller circuit.

13. The anti-icing solid state aircraft lamp of claim 12, wherein the at least one electrical resistive heater conductor comprises:
a first and second ends;
first and second terminals electrically coupled to the respective first and second ends of the at least one electrical resistive heater conductor;
wherein the least one electrical resistive heater conductor is arranged in a serpentine pattern on the optically transparent cover; and
wherein the first and second terminals are coupled to the controller circuit.

14. The anti-icing solid state aircraft lamp of claim 4, wherein the least one defroster element comprises a plurality of electrically resistive heater conductors arranged in a grid, wherein each of the plurality of electrically resistive heater conductors comprise first and second ends electrically coupled to respective first and second electrically conductive electrode pads, and wherein the first and second electrically conductive electrode pads are electrically coupled to the controller circuit.

15. The anti-icing solid state aircraft lamp of claim 4, wherein the at least one defroster element comprises an exothermic deicing thermal energy system.

16. The anti-icing solid state aircraft lamp of claim 15, wherein the exothermic deicing thermal energy system comprises:
a fluid connector configured to fluidically couple to a reservoir filled with deicing fluid;
a fluid line fluidically coupled to fluid connector;
a pump fluidically coupled to the fluid connector and the fluid line and electrically coupled to the controller circuit; and
a spray nozzle fluidically coupled to the fluid line.

17. The anti-icing solid state aircraft lamp of claim 4, wherein the at least one defroster element comprises an infrared thermal energy source electrically coupled to the controller circuit.

18. The anti-icing solid state aircraft lamp of claim 17, wherein the infrared thermal energy source comprises at least one infrared (IR) light emitting diode (LED).

19. The anti-icing solid state aircraft lamp of claim 17, wherein the infrared thermal energy source comprises a plurality of infrared (IR) light emitting diodes (LEDs) arranged in a circular array.

20. The anti-icing solid state aircraft lamp of claim 1, wherein the at least one defroster element comprises a thermal energy transfer system.

21. The anti-icing solid state aircraft lamp of claim 20, wherein the thermal energy transfer system comprises a metallic wire mesh thermally coupled to the solid state light source.

22. The anti-icing solid state aircraft lamp of claim 21, comprising:
a terminal coupled to the wire mesh; and
a thermal conductor having first and second ends, wherein the first end is coupled to the terminal and the second end is coupled to the solid light source.

23. A controller circuit for driving at least one defroster element coupled to a cover of an anti-icing solid state light source, the controller circuit comprising:
a control circuit;
a logic circuit coupled to the control circuit; and
an energy source coupled to the logic circuit and the at least one defroster element coupled to the cover of the anti-icing solid state light source in response to an input signal.

24. The controller circuit of claim 23, wherein the logic circuit is responsive to an activation input signal is configured to drive the energy source based on the activation input signal.

25. The controller circuit of claim 23, wherein the control circuit is coupled to a feedback element located on the cover, wherein the feedback element produces a feedback signal in response to conditions of the cover, and wherein the control circuit is configured to produce a signal in response to the feedback signal to drive the energy source based on the feedback signal.

26. The controller circuit of claim 25, wherein the feedback element is a temperature sensor.

27. The controller circuit of claim 26, wherein the temperature sensor is a thermistor.

28. The controller of claim 25, wherein the feedback element is a solid state ice sensor.

29. A method of deicing a solid state aircraft lamp, the solid state aircraft lamp comprising a substantially optically transparent cover optically coupled to at least one solid state light source and at least one defroster element coupled to the optically transparent cover, the method comprising:
monitoring a condition at the substantially optically transparent cover optically coupled to at least one solid state light source;
producing a signal in response to the condition;
applying the signal to a controller circuit electrically coupled to the at least one defroster element; and
activating an energy source coupled to the defroster element in response to the signal.

30. The method of claim 29, further comprising:
monitoring the condition at the substantially optically transparent cover optically coupled to at least one solid state light source using a feedback element;
wherein producing the signal comprises producing a feedback signal by the feedback element in response to the condition;
wherein applying the signal comprises applying a feedback signal to the controller circuit electrically coupled to the at least one defroster element; and
wherein activating the energy source coupled to the defroster element comprises activating the energy source in response to the feedback signal.

31. The method of claim 30, wherein producing the feedback signal comprises producing a voltage signal in response to the temperature at the optically transparent cover.

32. The method of claim 30, wherein producing the feedback signal comprises producing a voltage signal in response to ice formed on the optically transparent cover.

33. The method of claim 30, wherein the defroster element is a resistive coating formed on the cover, further comprising applying a voltage to the resistive coating by the energy source.

34. The method of claim 30, wherein the defroster element is a resistive grid embedded in the cover, further comprising applying a voltage to the resistive grid by the energy source.

35. The method of claim 30, wherein the defroster element is configured to generate thermal energy by exothermic chemical reaction that releases energy in the form of heat, further comprising activating the exothermic chemical reaction by the energy source.

36. The method of claim 30, wherein the defroster element is configured to generate infrared (IR) radiation energy, further comprising activating the IR radiation energy by the energy source.

37. The method of claim 30, wherein the defroster element is a heat sink to recover or recycle wasted heat from other sources in the solid state aircraft lamp, further comprising thermally transferring heat from the heat sink to the cover.
